(19) United States
(12) Patent Application Publication
(10) Pub. No.: US 2024/0373253 A1
(43) Pub. Date: Nov. 7, 2024

(54) WIRELESS DEVICE, NETWORK NODE, AND METHODS PERFORMED THEREBY FOR HANDLING A CONFIGURATION OF ONE OR MORE THRESHOLDS

(71) Applicant: Telefonaktiebolaget LM Ericsson (publ), Stockholm (SE)

(72) Inventors: Sina Maleki, Malmö (SE); Zhilan Xiong, Solna (SE); Mohammad Mozaffari, Fremont, CA (US); Stefan Wänstedt, Luleå (SE)

(21) Appl. No.: 18/686,067

(22) PCT Filed: Aug. 23, 2022
(86) PCT No.: PCT/SE2022/050760

§ 371 Date: Feb. 23, 2024

Related U.S. Application Data
(60) Provisional application No. 63/237,542, filed on Aug. 27, 2021.

(51) Int. Cl. H04W 24/02; H04W 8/22; H04W 28/02

(52) U.S. Cl. CPC H04W 24/02; H04W 8/22; H04W 28/0268

(57) ABSTRACT

A performed by a wireless device. The method is for handling a configuration of thresholds. The wireless device has a capability of harvesting energy. The wireless device operates in a wireless communications network. The wireless device determines a configuration of one or more thresholds. The one or more thresholds are based at least on a level of energy stored at the wireless device. The determining of the configuration is based on one or more conditions of the harvesting of the energy at the wireless device.

### TECHNICAL FIELD

The present disclosure relates generally to a wireless device, and methods performed thereby, for handling a configuration of thresholds. The present disclosure also relates generally to a network node and methods performed thereby for handling the configuration of thresholds.

### BACKGROUND

Wireless devices within a wireless communications network may be e.g., User Equipments (UE), stations (STAs), mobile terminals, wireless terminals, terminals, and/or Mobile Stations (MS). Wireless devices may be enabled to communicate wirelessly in a cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The wireless communications network covers a geographical area which may be divided into cell areas, each cell area being served by a network node, which may be an access node such as a radio network node, radio node or a base station, e.g., a Radio Base Station (RBS), which sometimes may be referred to as e.g., gNB, evolved Node B (“eNB”), “eNodeB”, “NodeB”, “B node”, Transmission Point (TP), or BTS (Base Transceiver Station), depending on the technology and terminology used. The base stations may be of different classes such as e.g., Wide Area Base Stations, Medium Range Base Stations, Local Area Base Stations, Home Base Stations, pico base stations, etc., based on transmission power and thereby also cell size. A cell may be understood as the geographical area where radio coverage is provided by the base station or radio node at a base station site, or radio node site, respectively. One base station, situated on the base station site, may serve one or several cells. Further, each base station may support one or several communication technologies. The base stations communicate over the air interface operating on radio frequencies with the terminals within range of the base stations. The wireless communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

### NR

The standardization organization 3rd Generation Partnership Project (3GPP) is currently in the process of specifying a New Radio Interface called New Radio (NR) or 5G-Universal Terrestrial Radio Access (UTRA), as well as a Fifth Generation (5G) Packet Core Network, which may be referred to as Next Generation (NG) Core Network, abbreviated as NG-CN, NGC or 5G CN.

In the current concept, gNB denotes an NR BS, where one NR BS may correspond to one or more transmission and/or reception points.

One of the main goals of NR is to provide more capacity for operators to serve ever increasing traffic demands and variety of applications. Because of this, NR may be able to operate on high frequencies, such as frequencies over 6 GHZ, until 60 or even 100 GHz.

Operation in higher frequencies makes it possible to use smaller antenna elements, which enables antenna arrays with many antenna elements. Such antenna arrays facilitate beamforming, where multiple antenna elements may be used to form narrow beams and thereby compensate for the challenging propagation properties.

### Internet of Things (IoT)

The Internet of Things (IoT) may be understood as an internetworking of communication devices, e.g., physical devices, vehicles, which may also be referred to as “connected devices” and “smart devices”, buildings and other items-embedded with electronics, software, sensors, actuators, and network connectivity that may enable these objects to collect and exchange data. The IoT may allow objects to be sensed and/or controlled remotely across an existing network infrastructure.

“Things,” in the IoT sense, may refer to a wide variety of devices such as heart monitoring implants, biochip transponders on farm animals, electric clams in coastal waters, automobiles with built-in sensors, DNA analysis devices for environmental/food/pathogen monitoring, or field operation devices that may assist firefighters in search and rescue operations, home automation devices such as the control and automation of lighting, heating, e.g. a “smart” thermostat, ventilation, air conditioning, and appliances such as washer, dryers, ovens, refrigerators or freezers that may use telecommunications for remote monitoring. These devices may collect data with the help of various existing technologies and then autonomously flow the data between other devices.

### Machine Type Communication (MTC)

Machine Type Communication (MTC) has in recent years, especially in the context of the Internet of Things (IoT), shown to be a growing segment for cellular technologies. An MTC device may be a communication device, typically a wireless communication device or simply user equipment, that may be understood to be a self and/or automatically controlled unattended machine and that may be understood to be typically not associated with an active human user in order to generate data traffic. An MTC device may be typically simpler, and typically associated with a more specific application or purpose, than, and in contrast to, a conventional mobile phone or smart phone. MTC may be understood to involve communication in a wireless communication network to and/or from MTC devices, which communication typically may be of quite different nature and with other requirements than communication associated with e.g. conventional mobile phones and smart phones. In the context of and growth of the IoT, it is evident that MTC traffic will be increasing and thus needs to be increasingly supported in wireless communication systems.

The next paradigm shift in processing and manufacturing is the Industry 4.0, in which factories may be automated and made much more flexible and dynamic with the help of wireless connectivity. This may include real-time control of robots and machines using time-critical machine-type communication (cMTC) and improved observability, control, and error detection with the help of large numbers of more simple actuators and sensors, e.g., massive machine-type communication (mMTC). For cMTC support, Ultra-Reliable Low-Latency Communication (URLLC) was introduced in 3GPP Release 15 for both LTE and NR, and NR URLLC may be understood to be further enhanced in Release 16 within the enhanced URLLC (eURLLC) and Industrial IoT work items.

For mMTC and Low Power Wide Area (LPWA) support, 3GPP introduced both Narrowband Internet-of-Things (NB-IoT) and Long-Term Evolution for Machine-Type Communications (LTE-MTC, or LTE-M) in Release 13. These technologies have been further enhanced through all releases up until and including the ongoing Release 17 work.

NR was introduced in 3GPP Release 15 and focused mainly on the enhanced mobile broadband (eMBB) and cMTC. However, there may be understood to be still several other use cases whose requirements may be higher than those of LPWA networks, e.g., LTE-M/NB-IoT, but lower than those of URLLC and eMBB. In order to efficiently support such use cases which may be in-between eMBB, URLLC, and mMTC, 3GPP has studied reduced capability NR devices (RedCap) in Release 17. The RedCap study item was completed in March 2021. A corresponding RedCap work item was started in December 2020 and is expected to be finalized in September 2022. The RedCap user equipments (UEs) may be understood to be required to have lower cost, lower complexity, a longer battery life, and potentially a smaller form factor than legacy NR UEs. Therefore, in Rel-17, different complexity reduction features, such as reduced maximum UE bandwidth, reduced minimum number of receiver branches, reduced maximum number of DL Multiple-Input and Multiple-Output (MIMO) layers, relaxed downlink modulation order, and support of half-duplex Frequency Division Duplex (FDD) operation will be specified for RedCap UEs.

The discussion on potential enhancements for RedCap in Rel-18 will soon begin in 3GPP. One of the potential enhancements may be related to support of RedCap UEs operating on harvested energy. The energy harvesting UEs are getting more attention as they may be self-sufficient, green and environmentally friendly and may ideally perform a perpetual operation. The source of the harvested energy may be, for example, vibration, radio waves, indoor office light, etc. A typical characteristic of energy harvesting UEs may be that the amount of energy that may be available to communicate with the network may often be varying drastically over time and may be a stochastic process.

In general, the harvested energy may not be used directly by the UE, but the UE may need to accumulate enough energy to perform an operation, e.g., a wireless transmission. Therefore, energy harvesting UEs may need rechargeable batteries or capacitors to enable the storage and management of the harvested energy.

### Energy Harvesting UEs and Quality of Service (QOS) Flows

FIG. 1 is a schematic diagram representing handling of packets from an application or service layer 1 in a UE 2, a gNB, represented in FIG. 1 as the Access Network (AN) 3, and a User Plane Function (UPF) 4. In 5G NR, incoming data packets from applications 5 may be classified into QoS Flows 6 based on Packet Detection Rules (PDRs) 7 in downlink and QoS rules 8 in uplink, and then mapped to AN resources 9, e.g., Data Radio Bearers (DRBs) for data transmission between UE and network. A QoS Flow may therefore be understood as a set of incoming data packets having its own QoS. Each QoS Flow may have its own 5G QoS Identifier (5QI), resource type, default priority level, packet delay budget, packet error rate, default maximum data burst volume, and default averaging window due to potentially different performance requirements for each service. However, these considered QoS Flows, applications, and services assume full energy at the UE side and currently do not consider the impact of energy harvesting.

To accommodate the varying energy level at the energy harvesting UEs with regard to QoS flows, in a non-published internal reference implementation, solutions are proposed for communication optimization between network and energy harvesting UE via multi-level energy configuration for different kinds of DRBs, QoS Flows, services, and/or applications as well as corresponding energy warning mechanisms with more details provided below, where QoS Flow (QOS-Flow) may be replaced by DRB, Application, Service, or QoS Service (QOS-Service) since DRBs/applications/services may have its individual requirements in terms of priority, latency, power consumption, power consumption rate, etc., Multi-level energy configuration may be understood as a configuration of levels of energy in the form of thresholds that may have to be attained to perform different actions.

Multi-level energy thresholds have been defined, including new QoS Flow state, QoS-Flow (enter) enabling threshold, QoS-Flow enter disabling threshold, transmission enabling enter threshold, transmission enabling leave threshold, transmission disabling enter threshold, transmission disabling leave threshold, energy warning entering threshold and energy warning leave threshold.

Multi-level energy threshold configurations such as network-based configuration, UE-based configuration and pre-configuration at the UE side have been described, as well as energy warning reporting, transmission state reporting and transmission state update reporting.

FIG. 2 is a schematic diagram representing data flows of a UE 21, a gNB 22, and a User Plane Function (UPF) 23. Data packets from six different services or applications 24, Service/application 1, Service/application 2, Service/application 3, Service/application 4, Service/application 5, Service/application 6 may be mapped to five different QoS Flows 25: QoS Flow 1, QoS Flow 2, QoS Flow 3, QoS Flow 4 and QoS Flow 5. The QoSs flows may in turn be mapped to four different DRBs 26: DRB 1, DRB 2, DRB 3, DRB 4.

It may be noted that QoS Flow (QOS-Flow) in this section may be replaced by DRB, Application, Service or QoS Service (QOS-Service), since applications/services may have its individual requirements in terms of priority, latency, power consumption, power consumption rate, and so on.

### Definitions

QoS Flow state: One QoS Flow may be associated with one state information. If this state is “on”, then this QoS Flow may be understood to be enabled. If this state is “off”, then this QoS Flow may be understood to be disabled. In another example, this state information may be ‘resuming’ and ‘suspending’. FIG. 3 is a schematic diagram representing QoS Flow state.

FIG. 4 is another schematic diagram representing another QoS Flow state, e.g., a QoS flow state for harvesting devices, wherein one QoS Flow may be associated with one state information. As depicted in the schematic diagram of FIG. 4, if this state is “enter-on”, then the data buffer of this QoS Flow may be understood to be enabled to accept new data. If this state is “enter-off”, then the data buffer of this QoS Flow may be understood to be disabled and will not accept new data. The data buffer of this QoS Flow may be data transmission buffer and/or data receive buffer.

QoS-Flow thresholds: As depicted in the schematic graphic representation of FIG. 5, one QoS Flow may have one QoS-Flow enabling threshold and one QoS-Flow disabling threshold to control its state switching. The state of one QoS Flow of one UE may be set to from ‘off’ to ‘on’ at time t1, when the energy level of this UE may be increased to its QoS-Flow enabling threshold and may be set from ‘on’ to ‘off’ at time 2, when the energy level of this UE may be decreased to its QoS-Flow disabling threshold.

QoS Flow enter thresholds: One QoS Flow may have one QoS-Flow enter enabling threshold and one QoS-Flow enter disabling threshold to control its state switching. As shown in the schematic graphic representation of FIG. 6, the state of one QoS Flow of one UE may be set to from ‘enter-off’ to ‘enter-on’ at time t1, when the energy level of this UE may be increased to its QoS-Flow enter enabling threshold, and may be set from ‘enter-on’ to ‘enter-off’ at time t2, when the energy level of this UE may be decreased to its QoS-Flow enter disabling threshold.

Transmission enabling thresholds: One QoS Flow may be associated with at least one of transmission enabling threshold, transmission enabling enter threshold and transmission enabling leave threshold to control its transmission enabling. As shown in the schematic graphic representation of FIG. 7, transmission enabling of a corresponding QoS Flow may be triggered at time t1, when the energy level of one UE may be increased to its transmission enabling enter threshold, and released at time t2, when the energy level of this UE may be reduced to its transmission enabling leave threshold.

Transmission disabling thresholds: One QoS Flow may be associated with at least one of transmission disabling threshold, transmission disabling enter threshold and transmission disabling leave threshold to control its transmission disabling. As shown in the schematic graphic representation of FIG. 8, transmission disabling of a corresponding QoS Flow may be triggered at time t1, when the energy level of one UE may be reduced to its transmission disabling enter threshold and released at time t2 when the energy level of this UE may be increased to its transmission disabling leave threshold.

Energy warning thresholds: The energy warning threshold may include one energy warning enter threshold and one energy warning leave threshold. As shown in the schematic graphic representation of FIG. 9, energy warning for a given condition may be triggered at time t1, when the energy level of one UE may be reduced to its energy warning enter threshold, and it may stop at time t2, when the energy level of this UE may be increased to its energy warning leave threshold.

### Multi-Level Energy Threshold Configuration

The thresholds defined in the previous Section entitled “Definitions” may be jointly defined and used. As shown in an example for joint multi-level energy thresholds in the schematic graphic representation of FIG. 10, for QoS Flow 2, and based on the energy level of a UE, an energy warning may be triggered at time t1, new data to transmission buffer may be disabled at time t2, data transmission may be disabled at time t3 due to the reduction of UE's energy level, but data transmission may be enabled at time t4, new data to transmission buffer may be enabled at time t5, and energy warning may be disabled at time t6.

### Pre-Configuration at UE Side

One UE may be pre-configured with one or more energy threshold sets, where one energy threshold set may be for one or more QoS Flow(s), or for this UE, for example, by services, operators, customers, vendors and so on, and may include one or more energy thresholds. One energy threshold set may be for one supported QoS Flow, each group of supported QoS Flows, or default QoS Flow. One energy threshold set may include at least one of the following thresholds: QoS-Flow enabling threshold, QoS-Flow disabling threshold, QoS-Flow enter enabling threshold, QoS-Flow enter disabling threshold, Transmission enabling threshold, Transmission enabling enter threshold, Transmission enabling leave threshold, Transmission disabling threshold, Transmission disabling enter threshold, Transmission disabling leave threshold, Energy warning enter threshold, and Energy warning leave threshold.

In spite of the benefits that energy harvesting may provide to UEs, existing methods to handle energy harvesting may result in wasted energy resources and other energy resources.

### SUMMARY

As part of the development of embodiments herein, one or more challenges with the existing technology will first be identified and discussed.

As mentioned in the Background section, one method to enable multi-level energy thresholds for energy harvesting UEs may be pre-configuration at the UE side, e.g., one UE may be pre-configured with one or more energy threshold sets, where one energy threshold set may be for one or more QoS Flow(s), or for this UE, for example, by service providers, operators, customers, vendors and so on, and may include one or more energy thresholds. The detail of how such a pre-configuration may be performed in practice is not fully described.

There is thus a need to develop methods and mechanisms with which the UE may determine the pre-configured energy thresholds in a more dynamic way. That is, in a way in which the dynamics of energy harvesting may be used to determine the thresholds.

According to the foregoing, it is an object of embodiments herein to improve the handling configuration of thresholds in a wireless communications network.

According to a first aspect of embodiments herein, the object is achieved by a method, performed by a wireless device. The method is for handling a configuration of thresholds. The wireless device has a capability of harvesting energy. The wireless device operates in the wireless communications network. The wireless device determines a configuration of one or more thresholds. The one or more thresholds are based at least on a level of energy stored at the wireless device. The determining of the configuration is based on one or more conditions of the harvesting of the energy at the wireless device.

According to a second aspect of embodiments herein, the object is achieved by a method, performed by a network node. The method is for handling the configuration of thresholds. The network node operates in the wireless communications network. The network node receives an indication, referred to herein as a third indication, from the wireless device operating in the wireless communications network. The wireless device has a capability of harvesting energy. The third indication indicates the configuration determined by the wireless device. The configuration is of one or more thresholds. The one or more thresholds are based at least on a level of energy stored at the wireless device. The configuration has been determined by the wireless device based on the one or more conditions of the harvesting of the energy at the wireless device.

According to a third aspect of embodiments herein, the object is achieved by the wireless device, for handling the configuration of the thresholds. The wireless device has the capability of harvesting energy. The wireless device operates in the wireless communications network. The wireless device determines the configuration of the one or more thresholds. The one or more thresholds are configured to be based at least on the level of energy configured to be stored at the wireless device. The determining of the configuration is configured to be based on the one or more conditions of the harvesting of the energy at the wireless device.

According to a fourth aspect of embodiments herein, the object is achieved by the network node, for handling the configuration of the thresholds. The network node is configured to operate in the wireless communications network. The network node is further configured to receive the third indication from the wireless device configured to operate in the wireless communications network. The wireless device is configured to have the capability of harvesting energy. The third indication is configured to indicate the configuration configured to be determined by the wireless device. The configuration is configured to be of the one or more thresholds. The one or more thresholds are configured to be based at least on the level of energy stored at the wireless device. The configuration is configured to have been determined by the wireless device based on the one or more conditions of the harvesting of the energy at the wireless device.

By the wireless device determining the configuration of the one or more thresholds based on the one or more conditions of the harvesting of the energy at the wireless device, the wireless device may be enabled to perform a dynamic pre-configuration of the energy thresholds at the wireless device. That is, the wireless device may be enabled to dynamically adapt the pre-configuration of its multi-level thresholds based on the change in the energy harvesting profile parameters, e.g., the harvesting type, such as solar, wind, piezoelectric, wireless power, etc., harvesting rate per unit of time, and energy storage capabilities. This dynamic adjustment may be beneficial for the operation of the wireless device, enabling an efficient usage of energy by the wireless device, efficient scheduling, resource utilization, and QoS optimization. For example, if the wireless device harvests a lot of energy and may thus be able to accommodate higher QoS, then better services may be enabled to be delivered to the wireless device, and resources may be utilized more optimally. If the harvested energy is low, and the thresholds are set for high QoS, no traffic may be delivered at all to the wireless device, the latency may be high and wireless device experience may be even worse than if at least some of the traffic may be able to be delivered.

By the network node receiving the third indication from the wireless device indicating the determined configuration, the network node may be enabled to remain aligned on specific energy thresholds with the wireless device. This may be understood to be relevant since, typically, the network node may perform actions related to scheduling based on QoS rules, so it may need to know if the wireless device may be able to accommodate a specific QoS based on harvested energy.

### BRIEF DESCRIPTION OF THE DRAWINGS

Examples of embodiments herein are described in more detail with reference to the accompanying drawings, and according to the following description.

FIG. 1 is a schematic diagram depicting handling of packets from an application or service layer in a UE, a gNB, and a UPF, according to existing methods.

FIG. 2 is a schematic diagram depicting an example of data flows of a UE, a gNB, and a UPF, according to existing methods.

FIG. 3 is a schematic diagram depicting an example of QoS Flow state, according to existing methods.

FIG. 4 is a schematic diagram depicting another example of QoS Flow state, according to existing methods.

FIG. 5 is a schematic diagram depicting an example of QoS-Flow thresholds, according to existing methods.

FIG. 6 is a schematic diagram depicting an example of QoS Flow enter thresholds, according to existing methods.

FIG. 7 is a schematic diagram depicting an example of Transmission enabling thresholds, according to existing methods.

FIG. 8 is a schematic diagram depicting an example of Transmission disabling thresholds, according to existing methods.

FIG. 9 is a schematic diagram depicting an example of Energy warning thresholds, according to existing methods.

FIG. 10 is a schematic diagram depicting an example for joint multi-level energy thresholds, according to existing methods.

FIG. 11 is a schematic diagram illustrating a wireless communications network, according to embodiments herein.

FIG. 12 is a flowchart depicting an example of a method performed by a wireless device, according to embodiments herein.

FIG. 13 is a flowchart depicting an example of a method performed by a network node, according to embodiments herein.

FIG. 14 is a schematic representation depicting a non-limiting example of a method according to embodiments herein.

FIG. 15 is a schematic block diagram illustrating two non-limiting examples, a) and b), of a wireless device, according to embodiments herein.

FIG. 16 is a schematic block diagram illustrating two non-limiting examples, a) and b), of a network node, according to embodiments herein.

FIG. 17 is a schematic block diagram illustrating a telecommunication network connected via an intermediate network to a host computer, according to embodiments herein.

FIG. 18 is a generalized block diagram of a host computer communicating via a base station with a user equipment over a partially wireless connection, according to embodiments herein.

FIG. 19 is a flowchart depicting embodiments of a method in a communications system including a host computer, a base station and a user equipment, according to embodiments herein.

FIG. 20 is a flowchart depicting embodiments of a method in a communications system including a host computer, a base station and a user equipment, according to embodiments herein.

FIG. 21 is a flowchart depicting embodiments of a method in a communications system including a host computer, a base station and a user equipment, according to embodiments herein.

FIG. 22 is a flowchart depicting embodiments of a method in a communications system including a host computer, a base station and a user equipment, according to embodiments herein.

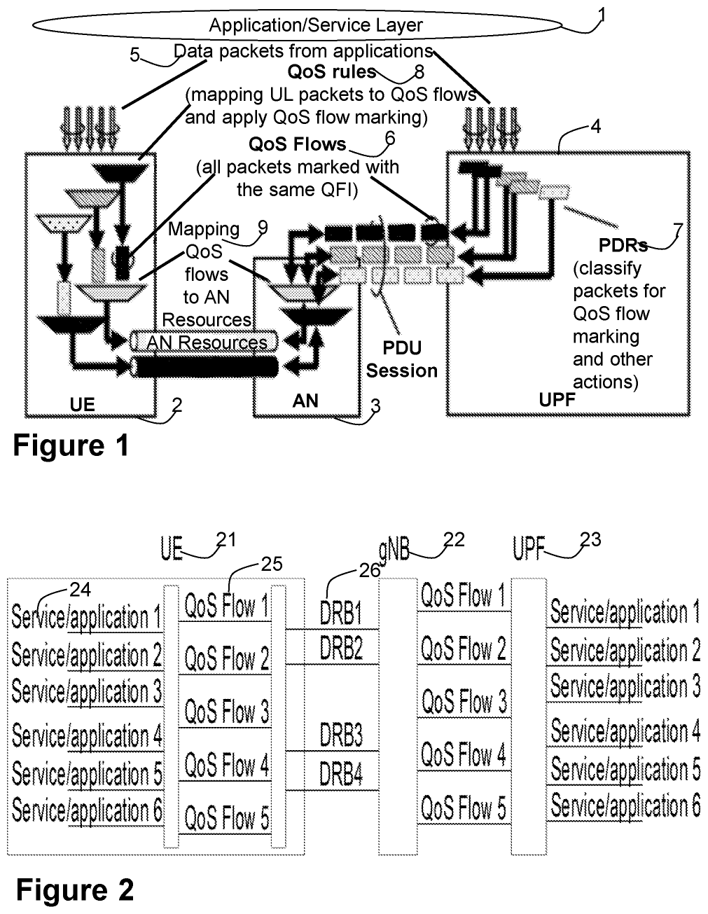

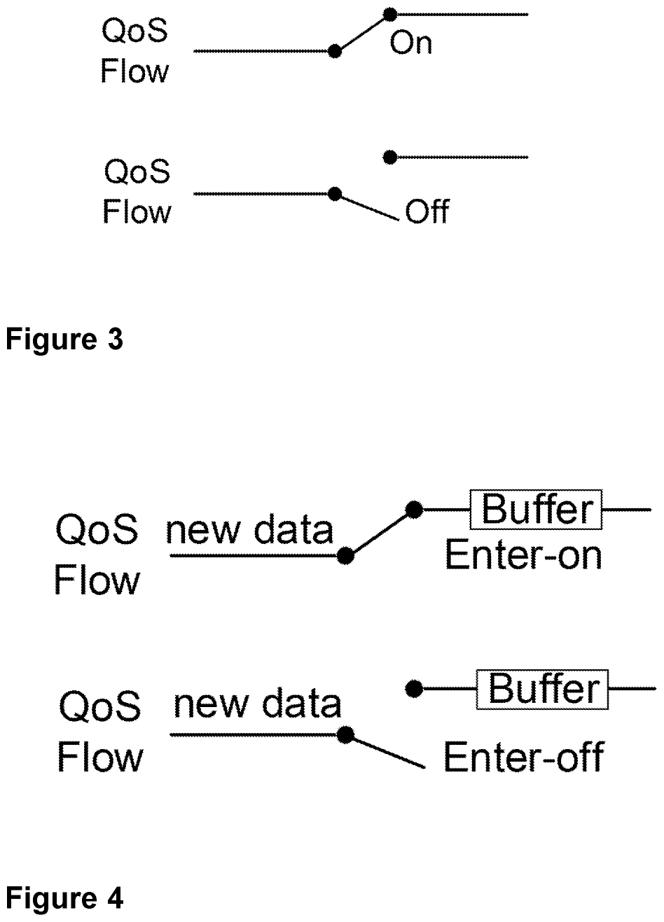

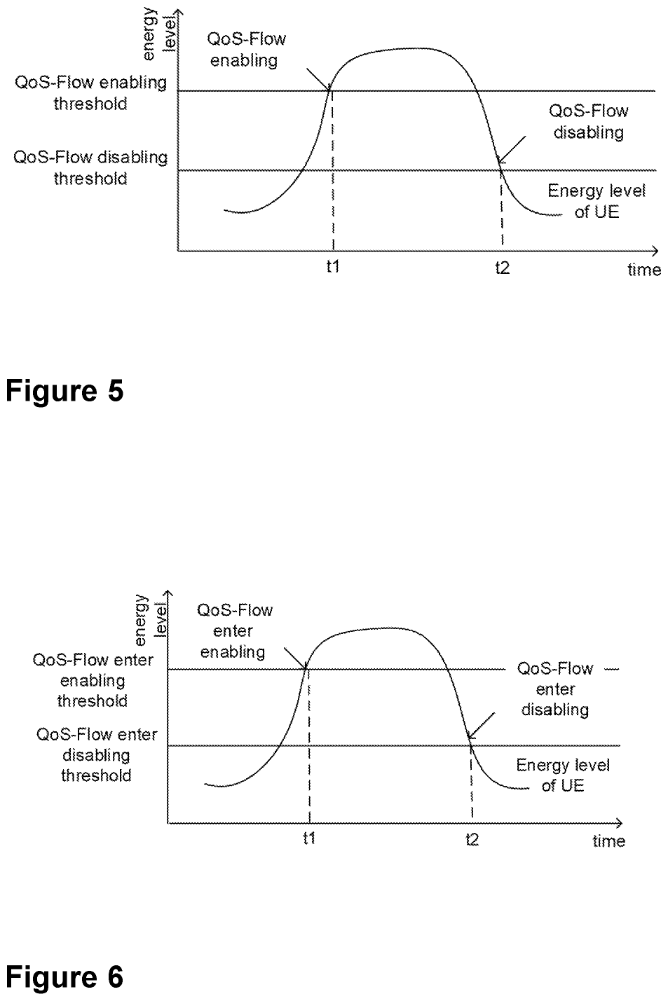

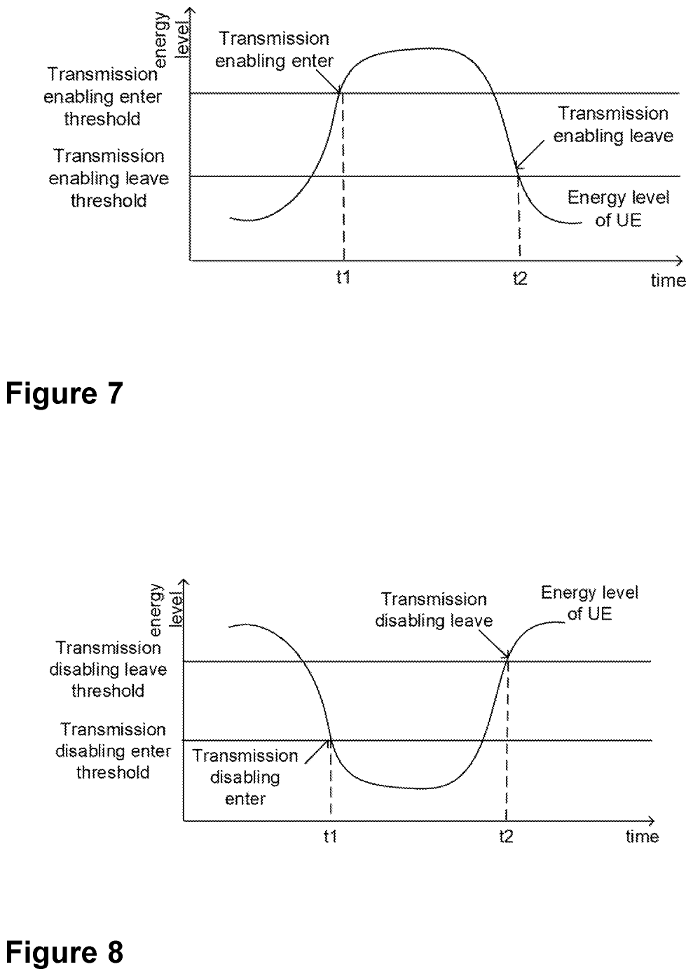

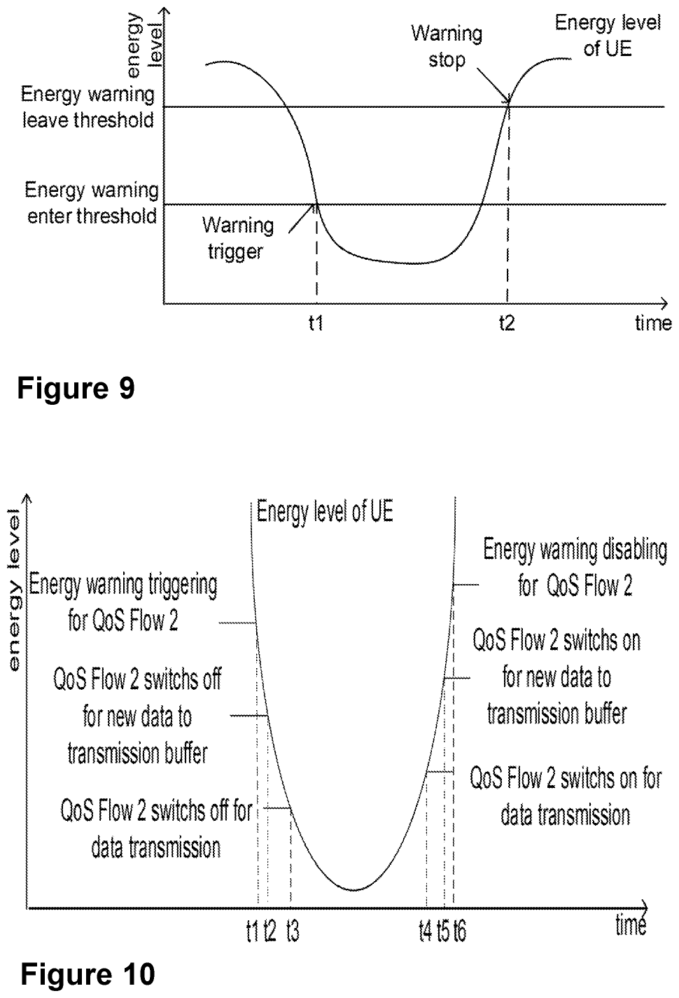

### DETAILED DESCRIPTION

Certain aspects of the present disclosure and their embodiments may provide solutions to the challenge discussed in the Summary section or other challenges. There are, proposed herein, various embodiments which address one or more of the issues disclosed herein.

As a general overview, embodiments herein relate to configuring energy thresholds in a more dynamic way. Particularly, embodiments herein may relate to configuring energy thresholds so that they may depend at least on energy harvesting profile parameters, e.g., the type of harvesting source, the rate of the harvesting, available energy storage, etc.,

Embodiments herein may therefore be understood to relate to dynamic pre-configuration of energy thresholds for UEs with harvested energy. Embodiments herein may be understood to also relate to methods and mechanisms with which a UE with the capability of energy harvesting may dynamically adapt the pre-configuration of its multi-level thresholds based on the change in the energy harvesting profile parameters, e.g., the harvesting type, such as solar, wind, piezoelectric, wireless power, etc., harvesting rate per unit of time, and energy storage capabilities.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

Note that although terminology from LTE/5G has been used in this disclosure to exemplify the embodiments herein, this should not be seen as limiting the scope of the embodiments herein to only the aforementioned system. Other wireless systems with similar features, may also benefit from exploiting the ideas covered within this disclosure.

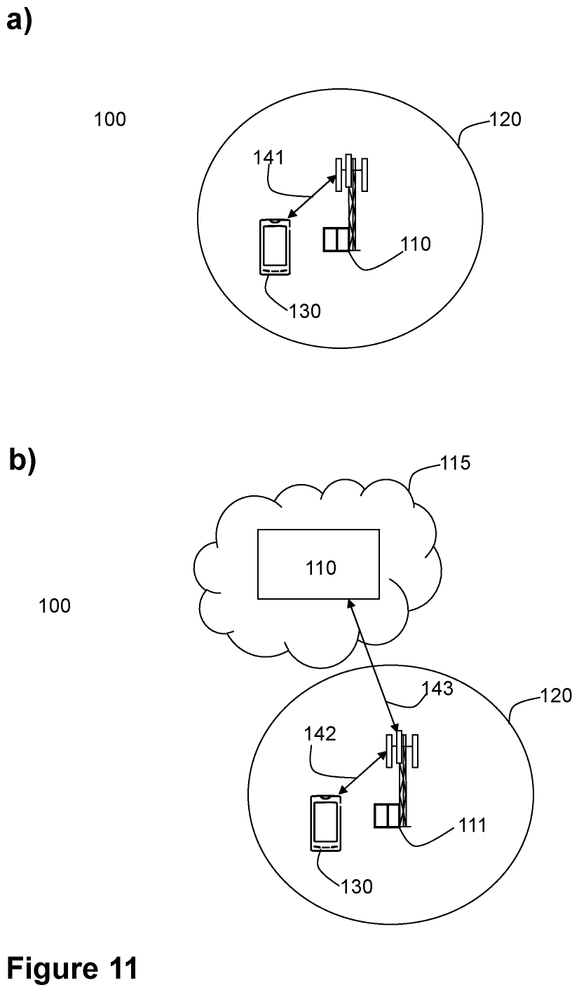

FIG. 11 depicts, in each of panel a) and panel b), two non-limiting examples of a wireless communications network 100, sometimes also referred to as a wireless communications system, cellular radio system, or cellular network, in which embodiments herein may be implemented. The wireless communications network 100 may typically be a 5G system, 5G network, NR-U or Next Gen System or network, Licensed-Assisted Access (LAA), or MulteFire. The wireless communications network 100 may support a younger system than a 5G system. The wireless communications network 100 may support other technologies, such as, for example Long-Term Evolution (LTE), LTE-Advanced/LTE-Advanced Pro, e.g. LTE Frequency Division Duplex (FDD), LTE Time Division Duplex (TDD), LTE Half-Duplex Frequency Division Duplex (HD-FDD), LTE operating in an unlicensed band, etc., Other examples of other technologies the wireless communications network 100 may support may be Wideband Code Division Multiple Access (WCDMA), Universal Terrestrial Radio Access (UTRA) TDD, Global System for Mobile Communications (GSM) network, Enhanced Data Rates for GSM Evolution (EDGE) network, GSM EDGE Radio Access Network (GERAN) network, Ultra-Mobile Broadband (UMB), network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), IoT, Narrowband Internet of Things (NB-IoT), or any cellular network or system. Thus, although terminology from 5G/NR and LTE may be used in this disclosure to exemplify embodiments herein, this should not be seen as limiting the scope of the embodiments herein to only the aforementioned systems.

As depicted in FIG. 11, the wireless communications network 100 comprises a network node 110. The network node 110 may be a radio network node, as depicted in the non-limiting example of panel a) in FIG. 11, or a core network node, as depicted in the non-limiting example of panel b) in FIG. 11. As a radio network node, the network node 110 may be a transmission point such as a radio base station, for example a gNB, an eNB, or any other network node with similar features capable of serving a wireless device, such as a user equipment or a machine type communication device, in the wireless communications network 100. In typical examples, the network node 110 may be a base station, such as a gNB. In other examples, the network node 110 may be a distributed node, such as a virtual node in the cloud, and may perform its functions entirely on the cloud, or partially, in collaboration with a radio network node. As a core network node, the network node 110 may be a core network node having a capability to take decisions regarding flows, that is, flows of traffic, e.g., data. In a non-limiting example, the network node 110 as core network node may be e.g., a UPF. As depicted in the non-limiting example of panel b), as a core network node, the network node 110 may be located in the cloud 115, and communicative with the wireless device 130 via a radio network node 111.

The wireless communications network 100 may cover a geographical area, which in some embodiments may be divided into cell areas, wherein each cell area may be served by a radio network node, although, one radio network node may serve one or several cells. In the example of FIG. 11, the network node 110 serves a cell 120. The network node 110 may be of different classes, such as, e.g., macro eNodeB, home eNodeB or pico base station, based on transmission power and thereby also cell size. In some examples, the network node 110 may serve receiving nodes with serving beams. The network node 110, e.g., as radio network node, may support one or several communication technologies, and its name may depend on the technology and terminology used. Any of the radio network nodes that may be comprised in the wireless communications network 100 may be directly connected to one or more core networks.

A plurality of wireless devices may be comprised in the wireless communication network 100, whereof a wireless device 130, is depicted in the non-limiting examples of FIG. 11. The wireless device 130 comprised in the wireless communications network 100 may be a wireless communication device such as a 5G UE, or a UE, which may also be known as e.g., mobile terminal, wireless terminal and/or mobile station, a Customer Premises Equipment (CPE) a mobile telephone, cellular telephone, or laptop with wireless capability, just to mention some further examples. Any of the wireless devices comprised in the wireless communications network 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, device equipped with a wireless interface, such as a printer or a file storage device, modem, or any other radio network unit capable of communicating over a radio link in a communications system. The wireless device 130 comprised in the wireless communications network 100 is enabled to communicate wirelessly in the wireless communications network 100. The communication may be performed e.g., via a RAN, and possibly the one or more core networks, which may be comprised within the wireless communications network 100. In particular embodiments, the wireless device 130 may be a RedCap device, or an Enhanced Reduced Capability NR Devices (eRedCap). In particular embodiments, the wireless device 130 may be an IoT device.

The wireless device 130 may be configured to communicate within the wireless communications network 100 with the network node 110 over a first link 141, e.g., a radio link, for example a first beam. The wireless device 130 may be configured to communicate within the wireless communications network 100 with the radio network node 11 over a second link 142, e.g., a radio link, for example a first beam. The network node 110 may be configured to communicate within the wireless communications network 100 with the radio network node 111 over a third link 143, e.g., a radio link or a wired link.

In general, the usage of “first”, “second”, and/or “third” herein may be understood to be an arbitrary way to denote different elements or entities, and may be understood to not confer a cumulative or chronological character to the nouns they modify.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

More specifically, the following are embodiments related to a network node, such as the network node 110, e.g., a gNB, and embodiments related to a wireless device, such as the wireless device 130, e.g., a UE.

Embodiments herein may relate to: energy harvesting, 5G, RedCap, Enhanced Reduced Capability NR Devices (eRedCap), IoT, Release 18 an/or Signaling.

Some embodiments herein will now be further described with some non-limiting examples.

In the following description, any reference to a/the network, and/or the network node, and/or “gNB”, and/or “the network” may be understood to equally refer to the network node 110; any reference to a/the UE may be understood to equally refer the wireless device 130.

It may be noted that QoS Flow (QOS-Flow) in this section may be replaced by DRB, Application, Service or QoS Service (QOS-Service), since applications and/or services may have their individual requirements in terms of priority, latency, power consumption, power consumption rate, and so on. In another case, QoS Flow (QOS-Flow) in this section may also be replaced by communication between network and considered UE.

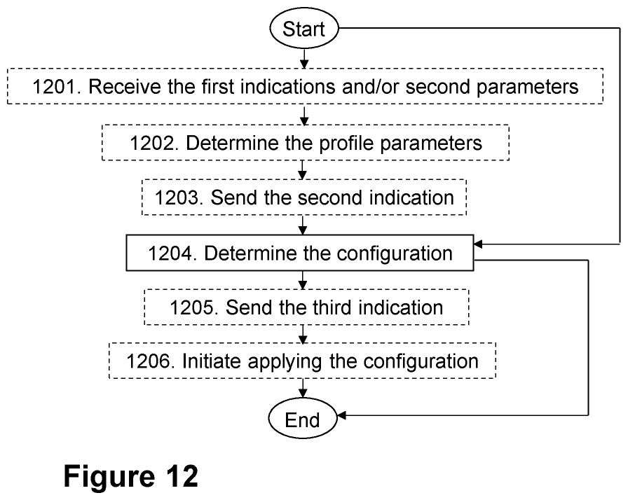

Embodiments of a method performed by a wireless device, such as the wireless device 130, will now be described with reference to the flowchart depicted in FIG. 12. The method may be understood to be for handling a configuration of one or more thresholds. The wireless device 130 has a capability of harvesting energy. The wireless device 130 operates in the wireless communications network 100.

The wireless communications network 100 may be a 5G network. In some embodiments, the wireless device 130 may be a 5G UE.

Several embodiments are comprised herein. In some embodiments all the actions may be performed. In some embodiments, one or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the wireless device 130 is depicted in FIG. 12. Some actions may be performed in a different order than that shown in FIG. 12.

In FIG. 12, actions which may be optional in some examples are depicted with dashed boxes.

### Action 1201

In this Action 1201, the wireless device 130 may receive, from the network node 110, at least one of: one or more first indications and one or more parameters. The one more parameters may be for energy harvesting. That is, any of the one or more parameters may characterize an aspect of the energy that may be harvested by the wireless device 130, and how it may be harvested. Examples of the parameters may be e.g., a) rate of harvesting of the energy or harvesting rate, e.g., rₕₐᵣᵥₑₛₜ, e.g., 0.1 joule per sec, namely 0.1 J/S, b) harvesting source type, e.g., electromagnetic power, solar, wind, piezoelectric, etc., c) energy storage capacity, e.g., 100 J or 200 J, and remaining energy. Remaining energy, or current energy level, may be understood as an amount of energy which may be understood to be currently available in the energy storage of the wireless device 130, just before a next harvesting instance.

The one or more parameters that the wireless device 130 may receive in this Action 1201 from the network node 110 may be understood to be other than one or more first parameters the wireless device 130 may determine itself. Other than may be understood to mean e.g., that the one or more parameters received in this Action 1201 may be partially or totally the same, or different, than the one or more first parameters. For example, the wireless device 130 may receive from the network node 110 one parameter, e.g., harvesting source type, which may be different than a first parameter, e.g., energy storage capacity, which the wireless device 130 may determine itself. Hence, the one or more parameters the wireless device 130 may receive in this Action 1201 may be referred to herein as one or more second parameters. In some examples, the network node 110 may be a gNB.

The one or more first indications may indicate a function to derive one or more third parameters. The one or more third parameters may be partially or totally the same, or different, than the one or more first parameters. An example of the one or more first indications may be, e.g., a formula. In one example, the network node 110 may indicate to the wireless device 130 which formula should be used by the wireless device 130 to calculate the underlying thresholds.

Receiving may be performed, e.g., via the first link 141. The receiving in this Action 1201 may be e.g., at the connection setup.

By receiving the at least one of the one or more first indications and the one or more second parameters from the network node 110 in this Action 1201, the wireless device 130 may be able to derive different aspects of energy harvesting, e.g., the energy warning status, for itself based on the adjustment information from the network node 110. Furthermore, the wireless device 130 may remain aligned with the network node 110 in the handling of energy harvesting.

### Action 1202

In this Action 1202, the wireless device 130 may determine a profile of parameters for energy harvesting. A profile of parameters may be understood as a set of one or more parameters and their respective values. The profile of parameters for energy harvesting may therefore characterize the energy harvesting at the wireless device 130.

The parameters may be based on at least one of: i) the one or more first parameters determined autonomously, e.g., predicted or based on a prediction, by the wireless device 130, ii) the one or more second parameters received from the network node 110 operating in the wireless communications network 100 in Action 1201, and iii) the one or more first indications received from the network node 110 in Action 1201. As stated earlier, the one or more first indications may indicate the function to derive the one or more third parameters.

In some embodiments, the parameters in the profile may comprise at least one of: a) a rate of harvesting of the energy or harvesting rate, e.g., rₕₐᵣᵥₑₛₜ, e.g., 0.1 joule per sec, namely 0.1 J/S, b) harvesting source type, e.g., electromagnetic power, solar, wind, piezoelectric, etc., c) energy storage capacity, e.g., 100 J or 200 J, and remaining energy.

Determining may be understood as calculating, deciding, deriving, or obtaining, e.g., from the network node 110.

The parameter rₕₐᵣᵥₑₛₜ may be calculated in different ways, determined in specifications, or configured by the network node 110, or left to the wireless device 130 implementation. For example, it may be the instantaneous rate, expected rate e.g., during t_{offset}, or average rate over a duration of time, etc. In another way, at least one of these parameters may be configured by the network in Action 1201, so that the wireless device 130 may be able to derive the energy warning status for itself based on the adjustment information from the network. In a specific example, the harvesting rate may be calculated as follows, wherein h_{type} may be understood to denote harvesting source type, and E_{cap} may be understood to denote the energy storage capacity:

$${r}_{harvest , t} = {R}_{1} ( {r}_{harvest , t - t 1} , {h}_{type} , {E}_{cap} , ... )$$

As mentioned in the Background section, one UE may be pre-configured with one or more energy threshold sets, where one energy threshold set may be for one or more QoS Flow(s), or for this wireless device 130, for example by servicer providers, operators, customers, vendors and so on, and may include one or more energy thresholds. One energy threshold set may be for one supported QoS Flow, each group of supported QoS Flows, or default QoS Flow. By determining the profile of parameters for energy harvesting in this Action 1202, the wireless device 130 may then be enabled to dynamically adapt the pre-configuration of its multi-level thresholds based on the change in the energy harvesting profile parameters, e.g., the harvesting type, such as solar, wind, piezoelectric, wireless power, etc., harvesting rate per unit of time, and energy storage capabilities. This dynamic adjustment may in turn be beneficial for operation of the wireless device 130, enabling an efficient usage of energy by the wireless device 130, efficient scheduling, resource utilization, and QoS optimization.

### Action 1203

In this Action 1203, the wireless device 130 may send a second indication to the network node 110. The second indication may indicate the determined profile.

Sending may be performed, e.g., via the first link 141.

By sending the determined profile to the network node 110 in this Action 1203, the wireless device 130 may be enabled to remain aligned, e.g., on specific energy thresholds, with the network node 110 in the handling of energy harvesting. For example, the wireless device 130 may send the parameter information to the network and also report the harvesting rate, e.g., rₕₐᵣᵥₑₛₜ, of the wireless device 130 to the network node 110, so that the network node 110 may be able to derive the energy warning status of this wireless device 130 based on collected information.

### Action 1204

In this Action 1204, the wireless device 130 determines a configuration of one or more thresholds. The one or more thresholds are based at least on a level of energy stored at the wireless device 130.

The one or more thresholds the configuration of which may be determined in this Action 1204 may comprise at least one of: i) an enabling threshold of at least one of: a QoS-Flow, a Data Radio Bearer (DRB), a service, and a QoS service, ii) a disabling threshold of at least one of: the QoS-Flow, the DRB, the service, and the QoS service, iii) an enter enabling threshold of at least one of: the QoS-Flow, the DRB, the service, and the QoS service, iv) an enter disabling threshold of at least one of: the QoS-Flow, the DRB, the service, and the QoS service, v) a transmission enabling threshold, vi) a transmission enabling enter threshold, e.g., of at least one of: the QoS-Flow, the DRB, the service, and the QoS service, vii) a transmission enabling leave threshold, e.g., of at least one of: the QoS-Flow, the DRB, the service, and the QoS service, viii) a transmission disabling threshold, e.g., of at least one of: the QoS-Flow, the DRB, the service, and the QoS service, ix) a transmission disabling enter threshold, e.g., of at least one of: the QoS-Flow, the DRB, the service, and the QoS service, x) a transmission disabling leave threshold, e.g., of at least one of: the QoS-Flow, the DRB, the service, and the QoS service, xi) an energy warning enter threshold, e.g., of at least one of: the QoS-Flow, the DRB, the service, and the QoS service, and xii) an energy warning leave threshold, e.g., of at least one of: the QoS-Flow, the DRB, the service, and the QoS service.

One energy threshold set may include at least one of the thresholds just described in the previous paragraph.

The at least one of the one or more thresholds may be for one of: a) data transmission, e.g., specifically data transmission, between the wireless communications network 100, e.g., the network node 110, and the wireless device 130, and b) wireless communication between the wireless communications network 100, e.g., the network node 110, and the wireless device 130, e.g., including control information or reference signals. In other words, any of the one or more thresholds may be for one of: data transmission, e.g., specifically, and wireless communication, e.g., in general.

The determining in this Action 1204 of the configuration is based on one or more conditions of the harvesting of the energy at the wireless device 130.

The one or more conditions may be based on the determined profile in Action 1202. That is, the determining in Action 1204 may be based on a profile of parameters for energy harvesting, e.g., the determined profile of parameters for energy harvesting. As a non-limiting example, the wireless device 130 may determine the configuration in Action 1204 based on the harvesting source type being wireless power, and a type of harvesting of energy being one of passive and active. That is, the wireless device 130 may, in Action 1204, determine different thresholds for the passive case and active case.

In one example, the pre-configured energy thresholds may be set for the wireless device 130, irrespective of the energy harvesting profile parameters, e.g., energy harvesting source type, such as, e.g., electromagnetic power, solar, wind, piezoelectric, etc., energy harvesting rate e.g., 0.1 joule per sec namely 0.1 J/S, energy storage capacity, e.g., 100 J, or energy harvesting pattern, e.g., based on a probability distribution function, and so on. In other words, the thresholds may be static, but according to embodiments herein, they may be made adjustable to the dynamics of energy harvesting.

In some embodiments, the one or more conditions may comprise a value of another of the one or more thresholds.

The one or more conditions may comprise a relationship between a current energy level parameter of the wireless device 130, a time parameter, e.g., an offset, and a harvesting rate parameter of the wireless device 130, with respect to a power parameter. A power parameter may be understood as a threshold on the power. For example, the one or more conditions may comprise:

$${p}_{current} + {t}_{offset} \times {r}_{harvest} \leq {p}_{1} ; or$$

$${p}_{current} + {t}_{offset} \times {r}_{harvest} \geq {p}_{2} ;$$

wherein p_{current} may be understood to be a current energy level parameter of the wireless device 130, t_{offset} may be understood to be a time parameter, rₕₐᵣᵥₑₛₜ may be understood to be a harvesting rate parameter of the wireless device 130, and each of p₁ and p₂ may be understood to be a power parameter.

For example, the energy warning enter may be based on the condition

$${p}_{current} + {t}_{offset} {\times }_{harvest} \leq {p}_{1}$$

and the energy warning leave may be based on the condition

$${p}_{current} + {t}_{offset} \times {r}_{harvest} \geq {p}_{2}$$

where p_{current} may be understood to be the current energy level of the wireless device 130, t_{offset} may be understood to be a time parameter, rₕₐᵣᵥₑₛₜ may be understood to be the harvesting rate of the wireless device 130, p₁ and p₂ may be understood to be the power parameters. The parameters t_{offset}, p₁ and p₂ may be may be understood to be pre-configured at the side of the wireless device 130, or derived by other parameters and information pre-configured at the side of the wireless device 130, e.g., in Action 1202, and the wireless device 130 may send, e.g., in Action 1203, the parameter information to the network and also report rₕₐᵣᵥₑₛₜ to the network, so that the network may be able to derive the energy warning status of this wireless device 130 based on collected information.

In some embodiments, at least one of the power parameters, e.g., p₁ and p₂, may be determined based on at least one of: a) one of the other parameters, such as the harvesting rate parameter, the harvesting source type, the harvesting source type, the energy storage capacity and the time parameter, and b) each other.

According to the first option, in an example, the pre-configured energy thresholds, e.g., p₁ and p₂ in the examples above may be a function of the energy harvesting profile parameters as described above, e.g., based on a formula as follows, wherein h_{type} may be understood to denote harvesting source type, and E_{cap} may be understood to denote the energy storage capacity:

$${p}_{1} = {f}_{1} ( {r}_{harvest} , {h}_{type} , {E}_{cap} , {t}_{offset} ... )$$

$${p}_{2} = {f}_{2} ( {r}_{harvest} , {h}_{type} , {E}_{cap} , {t}_{offset} ... )$$

For example, the wireless device 130 may be configured with a solar harvesting profile, and thus it may be expected that during a sunny day, the wireless device 130 may have access to a higher harvesting rate, and at night, the harvesting rate may be zero. As such, the wireless device 130 may be pre-configured with a lower transmission disabling threshold during the high harvesting rates, e.g., sunny days than e.g., during the night where the harvesting rate may be zero, and thus energy consumption may be even more critical. The same logic may be extended e.g., for the case of energy warning thresholds, e.g., during the sunny day, the energy warning enter threshold may be set lower compared to overnight or a cloudy day, and the energy warning leave thresholds may be set higher.

In another example of the one or more conditions, using available input parameters for the energy harvesting rate, the wireless device 130 may predict when there will be enough energy to transmit data with a certain QoS, given the pre-configured thresholds. With such information, e.g., the threshold for allowing new data into buffers may be opened at the right time. Input parameters may be, e.g., source of energy, for harvesting, time of day, for solar power, mobility pattern of device, and historical data. Information related to harvesting this time may optionally be forwarded to the data source of the data to be transmitted, especially if the sensor of the energy harvester is located in the device.

In another example, the harvesting source type may be wireless power and furthermore, it may be a passive one, or an active one. A passive wireless power harvesting, may receive the power from the ambient wireless transmissions, rectify and store them. On the other hand, an active wireless power harvesting may receive a wireless power which may have been intentionally transmitted to be harvested by the UEs with such a capability. In case of passive transfer, the wireless device 130 may not have access to a reliable source of power considering its access to power depends on the available wireless power in the environment which may change depending on the time, frequency, or area, while for the active one, the wireless device 130 may have access to a more predictable source of power. As such, it may be understood to make sense that the wireless device 130 may be pre-configured with different thresholds for the passive case and active case. For example, the wireless device 130 may be set with a lower transmission enabling threshold for the active case with respect to the passive case.

In a specific realization of the above example, the function may be e.g., a step function or a multi-dimensional step function based on one or more of the energy harvesting profile parameters, e.g., the wireless device 130 may be configured with a first harvesting profile, and at a time experiences a first harvesting rate. Then, the first harvesting rate may become larger than a threshold, and thus a second harvesting rate may be shaped, where at least one of the energy thresholds may be different based on the step function for the first and the second harvesting rate. Furthermore, the wireless device 130 may be associated with a second harvesting source, and a third harvesting rate. In one example, if the wireless device 130 at a time is configured only with one harvesting source, the step function may be associated e.g., to the harvesting rate, or the expected harvesting rate of the corresponding harvesting source. Nevertheless, if e.g., the first and the second harvesting sources coexist at the same time, in one approach, the function may be based on the summation of the harvesting rates, or the summation of the expected harvesting rates, or another function of the two first and second harvesting rate probability distribution functions. Alternatively, the pre-configured function may only be based on the harvesting source with the higher harvesting rate, or for the extreme robustness, only based on the harvesting source with a lower harvesting rate.

In the examples above, other energy harvesting profile parameters in addition to source and type may play a role as well as part of the pre-configured function. For example, the wireless device 130 may be configured with a first harvesting source, and a first harvesting rate but a first or a second storage, where the second storage may be larger than the first storage, and the two storages cannot be used at the same time. In case at a time, the first storage may be configured, and the second storage may be not available, the function may determine e.g., a higher energy warning enter threshold than the time that the second storage is available. For example, the wireless device 130 may be configured with a solar source, a harvesting rate of 0.1 J/S, and the storage may be either 100 J or 200 J, and the wireless device 130 may be active during a sunny day, that is, the rate may be stable. As such, the formula may provide a higher energy warning enter threshold e.g., 10 J, if the wireless device 130 uses the storage of 100 J, and a threshold of 5 J if the wireless device 130 uses the storage of 200 J.

In another embodiment, according to the second option, the pre-configured function in addition to the energy harvesting profile parameters may also depend on the interdependent abilities between other energy thresholds. For example, in one function, an energy warning enter threshold may be set to be at least the same or higher than a transmission disabling threshold. The reason may be that it may be important for the Network (NW) to know the wireless device 130 may be entering a critical energy storage zone before transmission or QoS flow may be disabled.

In another example, also according to the second option, the pre-configured energy thresholds, e.g., p₁ and p₂ may be dependent on each other. For example, p₂ may be determined based on p₁ using a pre-defined function:

p₂=f₃(p₁)

In a specific example, p₂=p₁+K, where K may be understood to be the offset between these thresholds. Also, K may be fixed or time-varying.

There may be scenarios where the wireless device 130 energy level may change very frequently and/or rapidly within a short period of time. This, in turn, may result in inefficient and frequent changes in energy warning enter/leave stages. To avoid such rapid fluctuations, a time window may be considered for applying the rules.

In some embodiments, a first condition of the one or more conditions may be a time window having expired. That is, the determining in Action 1204 of the configuration may be based on the time window having expired. According to these option, in another example, a time window may be considered after the energy level may pass or drops a threshold, and the rules may apply if the energy level may remain below/above the threshold for a defined window duration. Specifically, with the proviso that g(t)=[p_{current}+t_{offset}×rₕₐᵣᵥₑₛₜ], then
a) an energy warning enter may be based on the following condition:

$$g ( t : t + a ) \leq {p}_{1}$$

b) Similarly, the warning leave may be based on the following condition:

$$g ( t : t + b ) \geq {p}_{2}$$

where a and b may be understood to be the time windows within which the energy level may remain above/below thresholds. For example, if the energy level remains below p₁, during interval [t:t+a], then the energy warning enter may be satisfied.

By determining the configuration of the one or more thresholds based on the one or more conditions of the harvesting of the energy at the wireless device 130 in this Action 1204, the wireless device 130 may be enabled to perform a dynamic pre-configuration of the energy thresholds at the wireless device 130. That is, the wireless device 130 may be enabled to dynamically adapt the pre-configuration of its multi-level thresholds based on the change in the energy harvesting profile parameters, e.g., the harvesting type, such as solar, wind, piezoelectric, wireless power, etc., harvesting rate per unit of time, and energy storage capabilities. This dynamic adjustment may be beneficial for the operation of the wireless device 130, enabling an efficient usage of energy by the wireless device 130, efficient scheduling, resource utilization, and QoS optimization.

### Action 1205

In all the examples above, as explained earlier, it may be understood to be important that network node 110 and wireless device 130 may remain aligned on specific energy thresholds. In one example, the wireless device 130 may indicate to the network node 110 the employed pre-configured formula to calculate the underlying thresholds, e.g., at the connection setup, or alternatively, the network node 110 may indicate to the wireless device 130 which formula should be used for this purpose. For example, the wireless device 130 may choose a pre-configured formula based on the harvesting source type, or alternatively, indicate to the network node 110 of its harvesting source type may be sufficient to align network node 110 and the wireless device 130 on the employed formula.

In this Action 1205, the wireless device 130 may send a third indication to the network node 110 operating in the wireless communications network 100. The third indication may indicate the determined configuration.

Sending may be performed, e.g., via the first link 141.

In another example, once both network node 110 and the wireless device 130 may be aware of the pre-configured formula, in one approach, the wireless device 130 may indicate to the network node 110 the change in the thresholds, or alternatively, report the underlying energy harvesting profile parameters in Action 1203 to the network node 110, which may be used as input to the formula may be considered as sufficient for the network node 110 and wireless device 130 to be aligned on the use specific energy thresholds.

The network node 110 may configure the wireless device 130 through higher layers of its preferred approach, including both options, that is, to report both profile parameters and also the adopted thresholds. For example, the network node 110 may want to have better robustness with regard to the energy threshold alignment and thus configure the wireless device 130 with both reporting the energy harvesting profile parameters as well as reporting any updated energy thresholds. In both cases, the network node 110 may either configure the wireless device 130 with periodic reporting, semi-static or aperiodic. For example, the network node 110 may request the wireless device 130 on a periodic basis, e.g., using a Downlink Control Information (DCI), such that the wireless device 130 may report one or more of the underlying harvesting profile parameters or energy thresholds.

According to the foregoing, in some embodiments, the wireless device 130 may be configured by the network node 110 with at least one of: periodic, semi-static or aperiodic reporting, and the sending of at least one of the second indication and the third indication may be performed based on the configured reporting.

### Action 1206

In this Action 1206, the wireless device 130 may initiate applying the determined configuration.

Initiating may be understood as triggering, enabling, facilitating or starting.

By initiating the application of the determined configuration in this Action 1206, the wireless device 130 may be enabled to dynamically adapt the pre-configuration of its multi-level thresholds based on the change in the energy harvesting profile parameters, e.g., the harvesting type, such as solar, wind, piezoelectric, wireless power, etc., harvesting rate per unit of time, and energy storage capabilities. As stated earlier, this dynamic adjustment may be beneficial for the operation of the wireless device 130, enabling an efficient usage of energy by the wireless device 130, efficient scheduling, resource utilization, and QoS optimization.

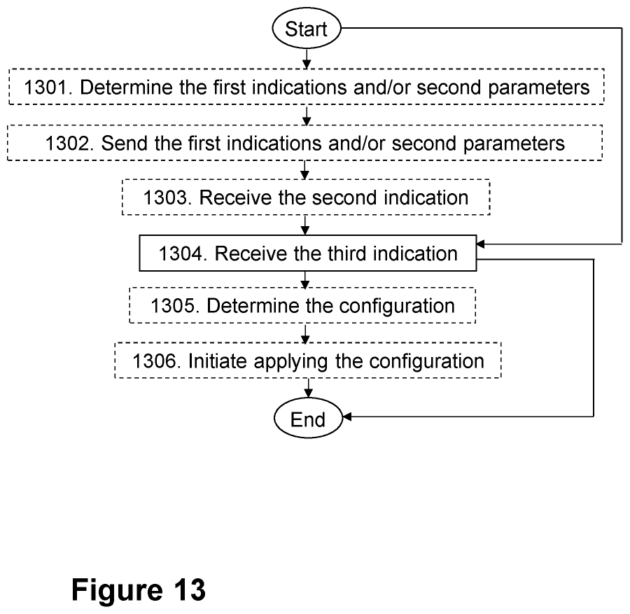

Embodiments of a method, performed by a network node, such as the network node 110, will now be described with reference to the flowchart depicted in FIG. 13. The method may be understood to be for handling the configuration of thresholds. The network node 110 operates in the wireless communications network 100.

Several embodiments are comprised herein. In some embodiments all the actions may be performed. In some embodiments, one or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the network node 110 is depicted in FIG. 13. In FIG. 13, actions which may be optional in some examples are depicted with dashed boxes. Some actions may be performed in a different order than that shown FIG. 13.

The detailed description of some of the features described for the method performed by the network node 110 corresponds to that already provided when describing the method performed by the wireless device 130 and will therefore not be repeated here. For example, in some embodiments, the wireless device 130 may be a 5G UE. In some embodiments, the network node 110 may be a gNB.

### Action 1301

In this Action 1301, the network node 110 may determine at least one of: a) the one or more first indications and b) the one or more second parameters for energy harvesting of the wireless device 130. The one or more first indications may indicate the function to derive the one or more third parameters.

At least one of the second parameters and the one or more third parameters may comprise at least one of: a) the rate of harvesting of the energy or harvesting rate, e.g., rₕₐᵣᵥₑₛₜ, e.g., 0.1 joule per sec, namely 0.1 J/S, b) the harvesting source type, e.g., electromagnetic power, solar, wind, piezoelectric, etc., c) the energy storage capacity, e.g., 100 J or 200 J, and d) the remaining energy.

### Action 1302

In some embodiments, in this Action 1302, the network node 110 may send, to the wireless device 130, at least one of: the one or more first indications and the one or more second parameters.

Sending may be performed, e.g., via the first link 141

### Action 1303

In some embodiments, the network node 110 may in this Action 1303, receive the second indication from the wireless device 130. The second indication may indicate the determined profile of parameters for energy harvesting.

Receiving may be performed, e.g., via the first link 141.

The second indication may indicate the determined profile of parameters for energy harvesting.

### Action 1304

In this Action 1304, the network node 110 receives the third indication from the wireless device 130 operating in the wireless communications network 100. The wireless device 130 has the capability of harvesting energy. The third indication indicates the configuration determined by the wireless device 130. The configuration is of the one or more thresholds. The one or more thresholds are based at least on the level of energy stored at the wireless device 130. The configuration has been determined by the wireless device 130 based on the one or more conditions of the harvesting of the energy at the wireless device 130.

The receiving may be performed, e.g., via the first link 141.

The one or more thresholds comprise at least one of: i) the enabling threshold of at least one of: the QoS-Flow, the DRB, the service, and the QoS service, ii) the disabling threshold of at least one of: the QoS-Flow, the DRB, the service, and the QoS service, iii) the enter enabling threshold of at least one of: the QoS-Flow, the DRB, the service, and the QoS service, iv) the enter disabling threshold of at least one of: the QoS-Flow, the DRB, the service, and the QoS service, v) the transmission enabling threshold, vi) the transmission enabling enter threshold, e.g., of at least one of: the QoS-Flow, the DRB, the service, and the QoS service, vii) the transmission enabling leave threshold, e.g., of at least one of: the QoS-Flow, the DRB, the service, and the QoS service, viii) the transmission disabling threshold, e.g., of at least one of: the QoS-Flow, the DRB, the service, and the QoS service, ix) the transmission disabling enter threshold, e.g., of at least one of: the QoS-Flow, the DRB, the service, and the QoS service, x) the transmission disabling leave threshold, e.g., of at least one of: the QoS-Flow, the DRB, the service, and the QoS service, xi) the energy warning enter threshold, e.g., of at least one of: the QoS-Flow, the DRB, the service, and the QoS service, and xii) the energy warning leave threshold, e.g., of at least one of: the QoS-Flow, the DRB, the service, and the QoS service.

The at least one of the one or more thresholds may be for one of: a) the data transmission, e.g., specifically data transmission, between the wireless communications network 100, e.g., the network node 110, and the wireless device 130, and b) the wireless communication between the wireless communications network 100, e.g., the network node 110, and the wireless device 130.

The one or more conditions may be based on the profile of parameters for energy harvesting of the wireless device 130. That is, the one or more conditions may be based on the determined profile, namely, the determined profile of parameters for energy harvesting of the wireless device 130, e.g., including control information or reference signals. In other words, any of the one or more thresholds may be for one of: data transmission, e.g., specifically and wireless communication, e.g., in general.

In some embodiments, the one or more conditions may comprise the value of another of the one or more thresholds.

In some examples, the one or more conditions may comprise the relationship between the current energy level parameter of the wireless device 130, the time parameter, e.g., the offset, and the harvesting rate parameter of the wireless device 130, with respect to the power parameter. For example, the one or more conditions may comprise:

$${p}_{current} + {t}_{offset} \times {r}_{harvest} \leq {p}_{1} ; or$$

$${p}_{current} + {t}_{offset} \times {r}_{harvest} \geq {p}_{2} ;$$

wherein p_{current} may be understood to be the current energy level parameter of the wireless device 130, t_{offset} may be understood to be the time parameter, rₕₐᵣᵥₑₛₜ may be understood to be the harvesting rate parameter of the wireless device 130, and each of p₁ and p₂ may be understood to be the power parameter.

In some embodiments, at least one power parameter, that is, at least one of the power parameters, e.g., p₁ and p₂, may be determined based on at least one of: a) one of the other parameters, such as the harvesting rate parameter, the harvesting source type, the harvesting source type and the time parameter; e.g., p₁=f₁(rₕₐᵣᵥₑₛₜ, h_{type}, E_{cap}, t_{offset} . . . ), p₂=f₂rₕₐᵣᵥₑₛₜ, h_{type}, E_{cap}, t_{offset} . . . , and b) each other, e.g., p₂=f₃p₁, p₂=p₁+K, where K may be understood to be the offset between tp₁ and p₂.

In some embodiments, a first condition of the one or more conditions may be a time window having expired, e.g., g(t:t+a)≤p₁, g(t:t+b)≥p₂, wherein g(t)=[p_{current}+t_{offset}×rₕₐᵣᵥₑₛₜ], and a and b may be understood to be the time windows within which the level of energy remains above and/or below the respective power parameter. That is, the determined configuration may be based on the time window having expired.

In some embodiments, the network node 110 may configure the wireless device 130 with at least one of: periodic, semi-static or aperiodic reporting, and the receiving of at least one of the second indication and the third indication may be performed based on the configured reporting.

### Action 1305

In this Action 1305, the network node 110 may determine, or update, the configuration of the one or more thresholds used by the wireless device 130, based on received third configuration.

The configuration of the one or more thresholds may be used, or to be used, by the wireless device 130.

By performing the determining in this Action 1305, the network node 110, e.g., as a radio network node serving the wireless device 130, and the wireless device 130 may be aligned. This may enable the network node 110 to manage one or more of its actions, e.g., with respect to the wireless device 130, accordingly. For example, if the wireless device 130 concludes that it does not have energy to perform a transmission to the network node 110, the network node 110 may be enabled to be aware of that, so it may refrain from listening to the wireless device 130, or refrain from requesting the wireless device 130 to perform the transmission until it has sufficient energy.

### Action 1306

In some embodiments, the network node 110 may in this Action 1306, initiate applying the determined configuration.

By performing the initiating applying in this Action 1306, the network node 110, e.g., as a radio network node serving the wireless device 130, the network node 110 may be enabled to manage one or more of its actions, e.g., with respect to the wireless device 130, according to the configuration used by the wireless device 130.

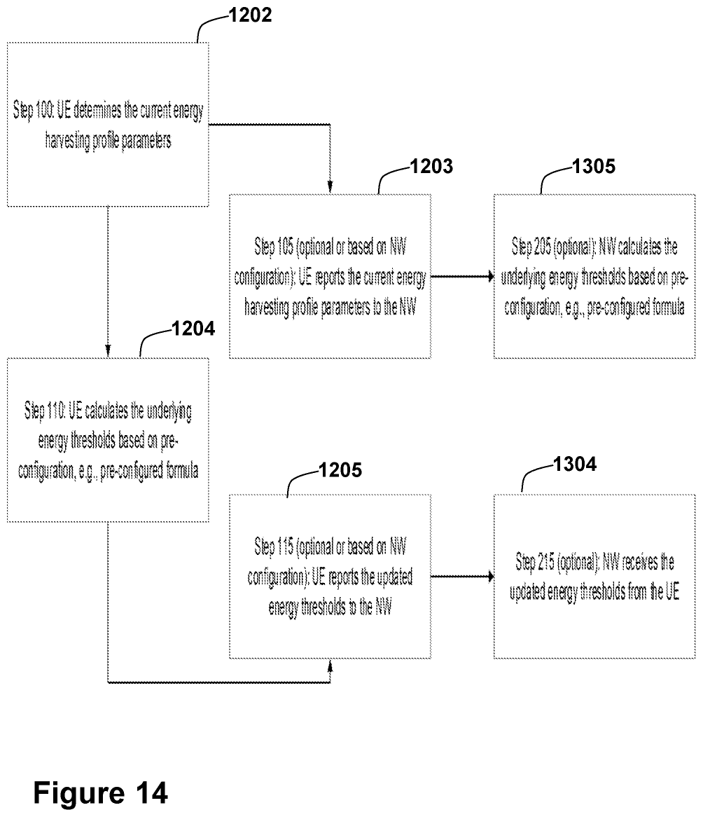

FIG. 14 is a non-limiting flow chart depicting an example of a method of how network node 110 and wireless device 130 may become aligned on the employed energy thresholds, according to embodiments herein. In Step 100, according to Action 1202, the wireless device 130, depicted as a UE in FIG. 14, may determine the current energy harvesting profile parameters. In Step 105, according to Action 1203, the wireless device 130 may optionally, or based on network configuration, report the current energy harvesting profile parameters to the network. Alternatively, or additionally, in Step 110, according to Action 1204, the wireless device 130 may calculate the underlying energy thresholds based on pre-configuration, e.g., on a pre-configured formula. In Step 115, according to Action 1205, the wireless device 130 may then, optionally or based on network configuration, report the updated energy thresholds to the network. In Step 205, according to Action 1305, the network node 110 may optionally calculate the underlying energy thresholds based on a pre-configuration, e.g., the pre-configured formula. Alternatively, or additionally, in Step 215, according to Action 1304, the network node 110 may receive the updated energy thresholds from the wireless device 130.

Certain embodiments disclosed herein may provide one or more of the following technical advantage(s), which may be summarized as follows. Embodiments herein may be beneficial for operation of the wireless device 130, energy efficiency of the wireless device 130, efficient scheduling, resource utilization, and QoS optimization. Furthermore, the wireless device 130 may dynamically adjust the energy thresholds according to the change in the energy harvesting profile parameters.

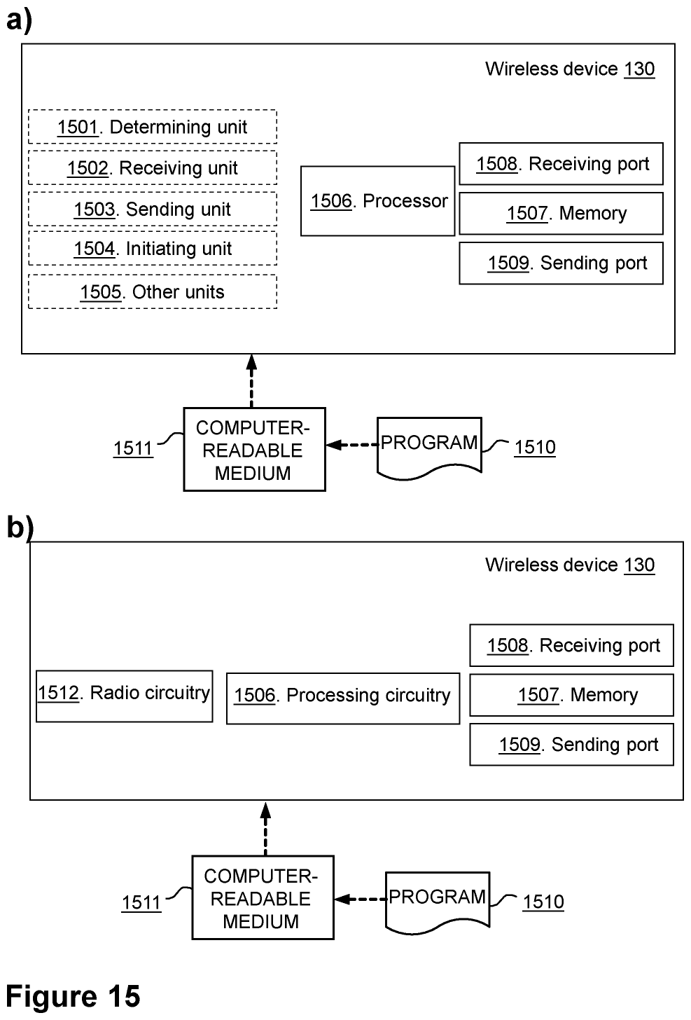

FIG. 15 depicts two different examples in panels a) and b), respectively, of the arrangement that the wireless device 130 may comprise. In some embodiments, the wireless device 130 may comprise the following arrangement depicted in FIG. 15a. The wireless device 130 may be understood to be for handling the configuration of thresholds. The wireless device 130 is configured to have the capability of harvesting energy. The wireless device 130 is configured to operate in the wireless communications network 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the wireless device 130, and will thus not be repeated here. For example, in some embodiments, the wireless device 130 may be configured to be a 5G UE. In some embodiments, the network node 110 may be configured to be a gNB.

In FIG. 15, optional units are indicated with dashed boxes.

The wireless device 130 is configured to perform the determining of Action 1204, e.g. by means of a determining unit 1501, configured to determine the configuration of the one or more thresholds. The one or more thresholds are configured to be based at least on the level of energy configured to be stored at the wireless device 130. The determining of the configuration is configured to be based on the one or more conditions of the harvesting of the energy at the wireless device 130.

In some embodiments, the one or more conditions may be configured to comprise: the value of another of the one or more thresholds.

In some embodiments, the wireless device 130 may be configured to perform the determining of Action 1202, e.g. by means of the determining unit 1501, configured to determine the profile of parameters for energy harvesting. The one or more conditions may be configured to be based on the determined profile. The parameters may be configured to be based on at least one of: i) the one or more first parameters configured to be determined autonomously by the wireless device 130, ii) the one or more second parameters configured to be received from the network node 110 configured to operate in the wireless communications network 100, and iii) the one or more first indications configured to be received from the network node 110. The one or more first indications may be configured to indicate the function to derive the one or more third parameters.

In some embodiments, the parameters in the profile may be configured to comprise at least one of: the rate of harvesting of the energy or harvesting rate, the harvesting source type, the energy storage capacity, and the remaining energy.

In some embodiments, the one or more conditions may be configured to comprise the relationship between the current energy level parameter of the wireless device 130, the time parameter, and the harvesting rate parameter of the wireless device 130, with respect to a power parameter, of the power parameters.

In some embodiments, at least one power parameter may be configured to be determined based on at least one of: the one of the other parameters and each other.

The wireless device 130 may be configured to perform the receiving of Action 1201, e.g. by means of a receiving unit 1502, configured to receive, from the network node 110, at least one of: the one or more first indications and the one or more second parameters.

The wireless device 130 may be configured to perform the sending of Action 1203, e.g. by means of a sending unit 1503, configured to send the second indication to the network node 110. The second indication may be configured to indicate the determined profile.

In some embodiments, the first condition of the one or more conditions may be configured to be the time window having expired.

The wireless device 130 may be configured to perform the sending of Action 1205, e.g. by means of the sending unit 1503, configured to send the third indication to the network node 110 configured to operate in the wireless communications network 100. The third indication may be configured to indicate the determined configuration.

In some embodiments, the one or more thresholds may be configured to comprise at least one of: i) the enabling threshold of at least one of: the QoS-Flow, the DRB, the service, and the QoS service, ii) the disabling threshold of at least one of: the QoS-Flow, the DRB, the service, and the QoS service, iii) the enter enabling threshold of at least one of: the QoS-Flow, the DRB, the service, and the QoS service, iv) the enter disabling threshold of at least one of: the QoS-Flow, the DRB, the service, and the QoS service, v) the transmission enabling threshold, vi) the transmission enabling enter threshold, vii) the transmission enabling leave threshold, viii) the transmission disabling threshold, ix) the transmission disabling enter threshold, x) the transmission disabling leave threshold, xi) the energy warning enter threshold, and xii) the energy warning leave threshold.

In some embodiments, the at least one of the one or more thresholds may be configured to be for one of: a) the data transmission between the wireless communications network 100 and the wireless device 130, and b) the wireless communication between the wireless communications network 100 and the wireless device 130.

The wireless device 130 may be configured to perform the initiating of Action 1206, e.g. by means of an initiating unit 1504, configured to initiate applying the configuration configured to be determined.

In some embodiments, the wireless device 130 may be configured to be configured by the network node 110 with at least one of: periodic, semi-static or aperiodic reporting. In some of such embodiments, the sending of at least one of the second indication and the third indication may be configured to be performed based on the reporting configured to be configured.

Other units 1505 may be comprised in the wireless device 130.

The embodiments herein in the wireless device 130 may be implemented through one or more processors, such as a processor 1506 in the wireless device 130 depicted in FIG. 15a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the wireless device 130. One such carrier may be in the form of a CD ROM disc. It is however feasible with other data carriers such as a memory stick. The computer program code may furthermore be provided as pure program code on a server and downloaded to the wireless device 130.

The wireless device 130 may further comprise a memory 1507 comprising one or more memory units. The memory 1507 is arranged to be used to store obtained information, store data, configurations, schedulings, and applications etc. to perform the methods herein when being executed in the wireless device 130.

In some embodiments, the wireless device 130 may receive information from, e.g., the network node 110, through a receiving port 1508. In some embodiments, the receiving port 1508 may be, for example, connected to one or more antennas in wireless device 130. In other embodiments, the wireless device 130 may receive information from another structure in the wireless communications network 100 through the receiving port 1508. Since the receiving port 1508 may be in communication with the processor 1506, the receiving port 1508 may then send the received information to the processor 1506. The receiving port 1508 may also be configured to receive other information.

The processor 1506 in the wireless device 130 may be further configured to transmit or send information to e.g., the network node 110 and/or another structure in the wireless communications network 100, through a sending port 1509, which may be in communication with the processor 1506, and the memory 1507.

Those skilled in the art will also appreciate that the units 1501-1505 described above may refer to a combination of analog and digital circuits, and/or one or more processors configured with software and/or firmware, e.g., stored in memory, that, when executed by the one or more processors such as the processor 1506, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1501-1505 described above may be implemented as one or more applications running on one or more processors such as the processor 1506.

Thus, the methods according to the embodiments described herein for the wireless device 130 may be respectively implemented by means of a computer program 1510 product, comprising instructions, i.e., software code portions, which, when executed on at least one processor 1506, cause the at least one processor 1506 to carry out the actions described herein, as performed by the wireless device 130. The computer program 1510 product may be stored on a computer-readable storage medium 1511. The computer-readable storage medium 1511, having stored thereon the computer program 1510, may comprise instructions which, when executed on at least one processor 1506, cause the at least one processor 1506 to carry out the actions described herein, as performed by the wireless device 130. In some embodiments, the computer-readable storage medium 1511 may be a non-transitory computer-readable storage medium, such as a CD ROM disc, or a memory stick. In other embodiments, the computer program 1510 product may be stored on a carrier containing the computer program 1510 just described, wherein the carrier is one of an electronic signal, optical signal, radio signal, or the computer-readable storage medium 1511, as described above.

The wireless device 130 may comprise a communication interface configured to facilitate communications between the wireless device 130 and other nodes or devices, e.g., the network node 110 and/or another structure. The interface may, for example, include a transceiver configured to transmit and receive radio signals over an air interface in accordance with a suitable standard.

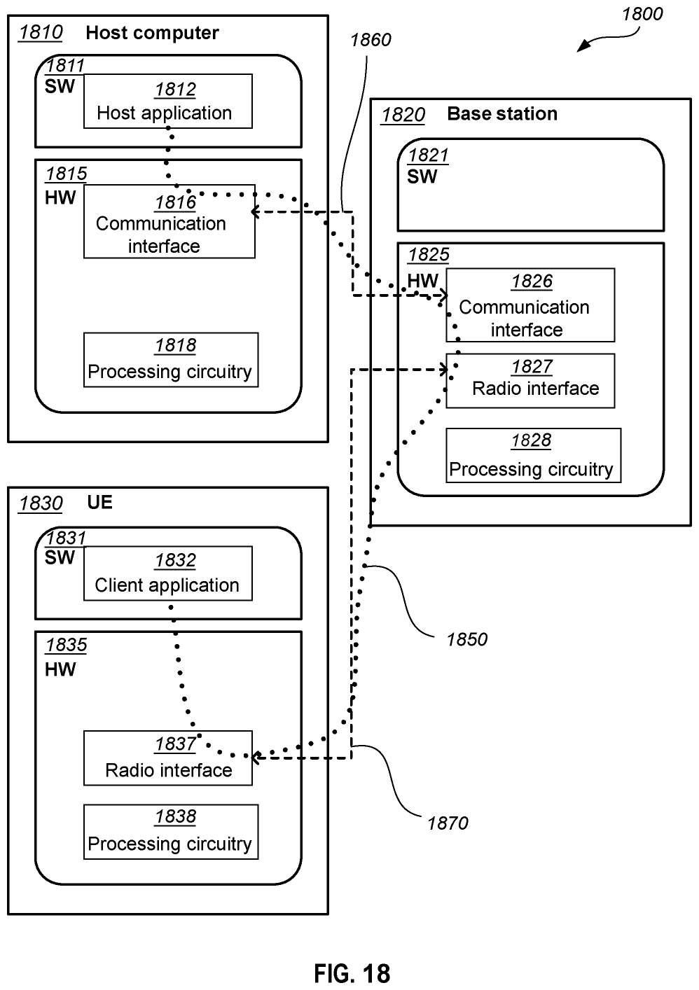

In other embodiments, the wireless device 130 may comprise the following arrangement depicted in FIG. 15b. The wireless device 130 may comprise a processing circuitry 1506, e.g., one or more processors such as the processor 1506, in the wireless device 130 and the memory 1507. The wireless device 130 may also comprise a radio circuitry 1512, which may comprise e.g., the receiving port 1508 and the sending port 1509. The processing circuitry 1506 may be configured to, or operable to, perform the method actions according to FIG. 12, FIG. 14 and/or FIGS. 18-22, in a similar manner as that described in relation to FIG. 15a. The radio circuitry 1512 may be configured to set up and maintain at least a wireless connection with the network node 110 and/or another structure. Circuitry may be understood herein as a hardware component.

Hence, embodiments herein also relate to the wireless device 130 operative to operate in the wireless communications network 100. The wireless device 130 may comprise the processing circuitry 1506 and the memory 1507, said memory 1507 containing instructions executable by said processing circuitry 1506, whereby the wireless device 130 is further operative to perform the actions described herein in relation to the wireless device 130, e.g., in FIG. 12, FIG. 14 and/or FIGS. 18-22.

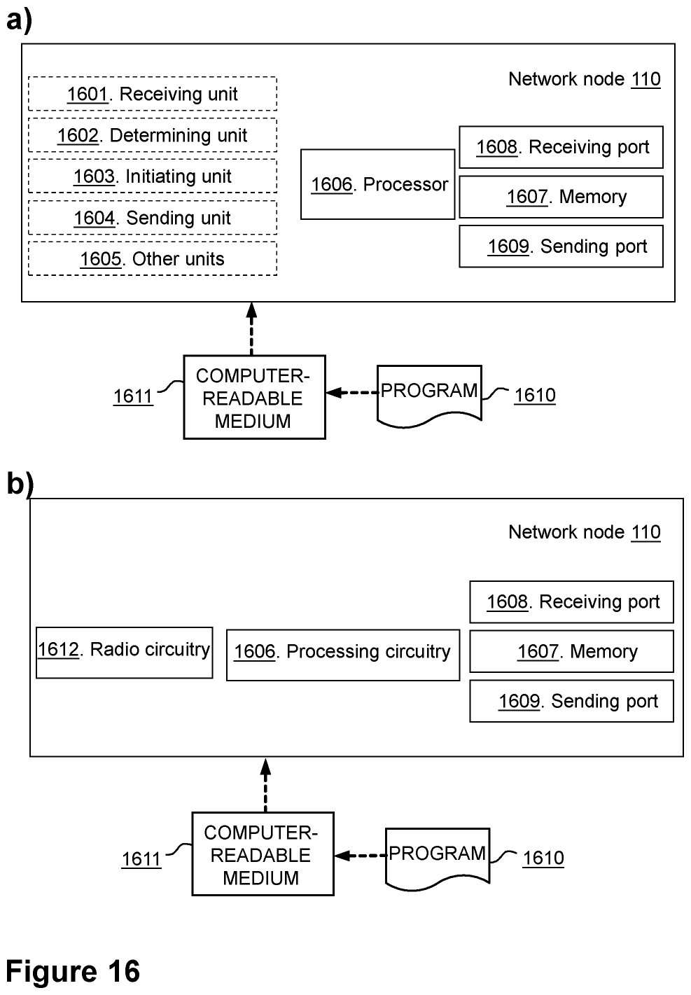

FIG. 16 depicts two different examples in panels a) and b), respectively, of the arrangement that the network node 110 may comprise. In some embodiments, the network node 110 may comprise the following arrangement depicted in FIG. 16a. The network node 110 may be understood to be for handling the configuration of thresholds. The network node 110 is configured to operate in the wireless communications network 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the network node 110, and will thus not be repeated here. For example, in some embodiments, the wireless device 130 may be configured to be a 5G UE. In some embodiments, the network node 110 may be configured to be a gNB.

In FIG. 16, optional units are indicated with dashed boxes.

The network node 110 is configured to perform this receiving Action 1304, e.g. by means of a receiving unit 1601 within the network node 110, configured to receive the third indication from the wireless device 130 configured to operate in the wireless communications network 100. The wireless device 130 may be configured to have a capability of harvesting energy, the third indication being configured to indicate a configuration configured to be determined by the wireless device 130, the configuration being configured to be of one or more thresholds, the one or more thresholds being configured to be based at least on a level of energy stored at the wireless device 130, the configuration being configured to have been determined by the wireless device 130 based on one or more conditions of the harvesting of the energy at the wireless device 130.

The network node 110 may be configured to perform the determining of Action 1305, e.g. by means of a determining unit 1602, configured to determine the configuration of the one or more thresholds configured to be used by the wireless device 130, based on the third configuration configured to be received.

The network node 110 may be configured to perform the initiating of this Action 1306, e.g. by means of an initiating unit 1603, configured to initiate applying the configuration configured to be determined.

In some embodiments, the one or more conditions may be configured to comprise: the value of the another of the one or more thresholds.

The network node 110 may be configured to perform the determining of this Action 1301, e.g. by means of the determining unit 1602, configured to determine at least one of: a) the one or more first indications and b) the one or more second parameters for energy harvesting of the wireless device 130. The one or more first indications may be configured to indicate the function to derive the one or more third parameters.

In some embodiments, at least one of the second parameters and the one or more third parameters may be configured to comprise at least one of: the rate of harvesting of the energy or harvesting rate, the harvesting source type, the energy storage capacity, and the remaining energy.

In some embodiments, the one or more conditions may be configured to comprise the relationship between the current energy level parameter of the wireless device 130, the time parameter, and the harvesting rate parameter of the wireless device 130, with respect to a power parameter, of the power parameters.

In some embodiments, at least one power parameter may be configured to be determined based on at least one of: the one of the other parameters and each other.

The network node 110 may be configured to perform this sending Action 1302, e.g. by means of a sending unit 1604 within the network node 110, configured to send, to the wireless device 130, at least one of: the one or more first indications and the one or more second parameters.

The network node 110 may be configured to perform this receiving Action 1303, e.g. by means of the receiving unit 1601 within the network node 110, configured to receive the second indication from the wireless device 130. The second indication may be configured to indicate the determined profile of parameters for energy harvesting. The one or more conditions may be configured to be based on the determined profile.

In some embodiments, the first condition of the one or more conditions may be configured to be the time window having expired.

In some embodiments, the one or more thresholds may be configured to comprise at least one of: i) the enabling threshold of at least one of: the QoS-Flow, the DRB, the service, and the QoS service, ii) the disabling threshold of at least one of: the QoS-Flow, the DRB, the service, and the QoS service, iii) the enter enabling threshold of at least one of: the QoS-Flow, the DRB, the service, and the QoS service, iv) the enter disabling threshold of at least one of: the QoS-Flow, the DRB, the service, and the QoS service, v) the transmission enabling threshold, vi) the transmission enabling enter threshold, vii) the transmission enabling leave threshold, viii) the transmission disabling threshold, ix) the transmission disabling enter threshold, x) the transmission disabling leave threshold, xi) the energy warning enter threshold, and xii) the energy warning leave threshold.

In some embodiments, the at least one of the one or more thresholds may be configured to be for one of: a) the data transmission between the wireless communications network 100 and the wireless device 130, and b) the wireless communication between the wireless communications network 100 and the wireless device 130.

In some embodiments, the network node 110 may be configured to configure the wireless device 130 with at least one of: periodic, semi-static or aperiodic reporting. In some of such embodiments, the receiving of at least one of the second indication and the third indication may be configured to be performed based on the reporting configured to be configured.

Other units 1605 may be comprised in the network node 110.

The embodiments herein in the network node 110 may be implemented through one or more processors, such as a processor 1606 in the network node 110 depicted in FIG. 16a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The network node 110 may further comprise a memory 1607 comprising one or more memory units. The memory 1607 is arranged to be used to store obtained information, store data, configurations, schedulings, and applications etc. to perform the methods herein when being executed in the network node 110.

In some embodiments, the network node 110 may receive information from, e.g., the wireless device 130, through a receiving port 1608. In some embodiments, the receiving port 1608 may be, for example, connected to one or more antennas in network node 110. In other embodiments, the network node 110 may receive information from another structure in the wireless communications network 100 through the receiving port 1608. Since the receiving port 1608 may be in communication with the processor 1606, the receiving port 1608 may then send the received information to the processor 1606. The receiving port 1608 may also be configured to receive other information.

The processor 1606 in the network node 110 may be further configured to transmit or send information to e.g., the wireless device 130 and/or another structure in the wireless communications network 100, through a sending port 1609, which may be in communication with the processor 1606, and the memory 1607.

Those skilled in the art will also appreciate that the units 1601-1605 described above may refer to a combination of analog and digital circuits, and/or one or more processors configured with software and/or firmware, e.g., stored in memory, that, when executed by the one or more processors such as the processor 1606, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1601-1605 described above may be implemented as one or more applications running on one or more processors such as the processor 1606.

Thus, the methods according to the embodiments described herein for the network node 110 may be respectively implemented by means of a computer program 1610 product, comprising instructions, i.e., software code portions, which, when executed on at least one processor 1606, cause the at least one processor 1606 to carry out the actions described herein, as performed by the network node 110. The computer program 1610 product may be stored on a computer-readable storage medium 1611. The computer-readable storage medium 1611, having stored thereon the computer program 1610, may comprise instructions which, when executed on at least one processor 1606, cause the at least one processor 1606 to carry out the actions described herein, as performed by the network node 110. In some embodiments, the computer-readable storage medium 1611 may be a non-transitory computer-readable storage medium, such as a CD ROM disc, or a memory stick. In other embodiments, the computer program 1610 product may be stored on a carrier containing the computer program 1610 just described, wherein the carrier is one of an electronic signal, optical signal, radio signal, or the computer-readable storage medium 1611, as described above.

The network node 110 may comprise a communication interface configured to facilitate communications between the network node 110 and other nodes or devices, e.g., the wireless device 130 and/or another structure in the wireless communications network 100. The interface may, for example, include a transceiver configured to transmit and receive radio signals over an air interface in accordance with a suitable standard.

In other embodiments, the network node 110 may comprise the following arrangement depicted in FIG. 16b. The network node 110 may comprise a processing circuitry 1606, e.g., one or more processors such as the processor 1606, in the network node 110 and the memory 1607. The network node 110 may also comprise a radio circuitry 1612, which may comprise e.g., the receiving port 1608 and the sending port 1609. The processing circuitry 1606 may be configured to, or operable to, perform the method actions according to FIG. 13, FIG. 14 and/or FIGS. 18-22, in a similar manner as that described in relation to FIG. 16a. The radio circuitry 1612 may be configured to set up and maintain at least a wireless connection with the the wireless device 130 and/or another structure in the wireless communications network 100. Circuitry may be understood herein as a hardware component.

Hence, embodiments herein also relate to the network node 110 operative to operate in the wireless communications network 100. The network node 110 may comprise the processing circuitry 1606 and the memory 1607, said memory 1607 containing instructions executable by said processing circuitry 1606, whereby the network node 110 is further operative to perform the actions described herein in relation to the network node 110, e.g., in FIG. 13, FIG. 14 and/or FIGS. 18-22.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

When using the word “comprise” or “comprising” it shall be interpreted as non-limiting, i.e. meaning “consist at least of”.

A processor may be understood herein as a hardware component.

The embodiments herein are not limited to the above described preferred embodiments. Various alternatives, modifications and equivalents may be used. Therefore, the above embodiments should not be taken as limiting the scope of the invention.

### Examples of, or Related to, Embodiments Herein

Examples related to embodiments herein may be as follows.

Example 1. A method performed by a wireless device (130), the method being for handling a configuration of thresholds, the wireless device (130) having a capability of harvesting energy, the wireless device (130) operating in a wireless communications network (100), the method comprising:
determining (1204) a configuration of one or more thresholds, the one or more thresholds being based at least on a level of energy stored at the wireless device (130), the determining (1204) of the configuration being based on one or more conditions of the harvesting of the energy at the wireless device (130).

Example 2. The method according to example 1, wherein the one or more conditions comprise:
a value of another of the one or more thresholds.

Example 3. The method according to any of examples 1-2, further comprising:
determining (1202) a profile of parameters for energy harvesting, and wherein the one or more conditions are based on the determined profile, wherein the parameters are based on at least one of:
   i. one or more first parameters determined autonomously by the wireless device (130),
   ii. one or more second parameters received from a network node (110) operating in the wireless communications network (100), and
   iii. one or more first indications received from the network node (110), the one or more first indications indicating a function to derive one or more third parameters.

Example 4. The method according to example 3, wherein the parameters in the profile comprise at least one of:
a rate of harvesting of the energy or harvesting rate, e.g., rₕₐᵣᵥₑₛₜ,
harvesting source type,
energy storage capacity, and
remaining energy.

Example 5. The method according to any of examples 1-4, wherein the one or more conditions comprise a relationship between a current energy level parameter of the wireless device 130, a time parameter, e.g., an offset, and a harvesting rate parameter of the wireless device 130, with respect to a power parameter; for example, the one or more conditions may comprise:

$${p}_{current} + {t}_{offset} \times {r}_{harvest} \leq {p}_{1} ; or$$

$${p}_{current} + {t}_{offset} \times {r}_{harvest} \geq {p}_{2} ;$$

wherein p_{current} is a current energy level parameter of the wireless device (130), t_{offset} is a time parameter, harvest is a harvesting rate parameter of the wireless device (130), and each of p₁ and p₂ is a power parameter.

Example 6. The method according to example 5 and any of examples 3-4, wherein at least one of the power parameters, e.g., p₁ and p₂, is determined based on at least one of:
one of the other parameters, such as the harvesting rate parameter, the harvesting source type, the harvesting source type and the time parameter;

$$e . g . , {p}_{1} = {f}_{1} ( {r}_{harvest} , {h}_{type} , {E}_{cap} , {t}_{offset} ... ) , \\ {p}_{2} = {f}_{2} ( {r}_{harvest} , {h}_{type} , {E}_{cap} , {t}_{offset} ... ) ,$$

and
each other, e.g., p₂=f₃(p₁), p₂=p₁+K, where K is the offset between tp₁ and p₂.

Example 7. The method according to any of examples 3-6, further comprising:
receiving (1201), from the network node (110), at least one of: the one or more first indications and the one or more second parameters.

Example 8. The method according to any of examples 3-7, further comprising:
sending (1203) a second indication to the network node (110), the second indication indicating the determined profile.

Example 9. The method according to any of examples 1-8, wherein a first condition of the one or more conditions is a time window having expired, e.g., g(t:t+a)≤p₁, g(t:t+b)≥p₂, wherein g(t)=[p_{current}+t_{offset}×rₕₐᵣᵥₑₛₜ], and a and b are the time windows within which the level of energy remains above and/or below the respective power parameter.

Example 10. The method according to any of examples 1-9, further comprising:
sending (1205) a third indication to a network node (110) operating in the wireless communications network (100), the third indication indicating the determined configuration.

Example 11. The method according to any of examples 1-10, wherein the one or more thresholds comprise at least one of:
an enabling threshold of at least one of: a Quality of Service, QoS-Flow, a Data Radio Bearer, DRB, a service, and a QoS service,
a disabling threshold of at least one of: the QoS-Flow, the DRB, the service, and the QoS service,
an enter enabling threshold of at least one of: the QoS-Flow, the DRB, the service, and the QoS service,
an enter disabling threshold of at least one of: the QoS-Flow, the DRB, the service, and the QoS service,
a transmission enabling threshold, e.g., of at least one of: the QoS-Flow, the DRB, the service, and the QoS service,
a transmission enabling enter threshold, e.g., of at least one of: the QoS-Flow, the DRB, the service, and the QoS service,
a transmission enabling leave threshold, e.g., of at least one of: the QoS-Flow, the DRB, the service, and the QoS service, a transmission disabling threshold, e.g., of at least one of: the QoS-Flow, the DRB, the service, and the QoS service,
a transmission disabling enter threshold, e.g., of at least one of: the QoS-Flow, the DRB, the service, and the QoS service,
a transmission disabling leave threshold, e.g., of at least one of: the QoS-Flow, the DRB, the service, and the QoS service,
an energy warning enter threshold, e.g., of at least one of: the QoS-Flow, the DRB, the service, and the QoS service, and
an energy warning leave threshold, e.g., of at least one of: the QoS-Flow, the DRB, the service, and the QoS service.

Example 12. The method according to example 11, wherein the at least one of the one or more thresholds is for one of: a) data transmission, e.g., specifically data transmission, between the wireless communications network 100, e.g., the network node 110 and the wireless device 130, and b) wireless communication between the wireless communications network 100, e.g., the network node 110 and the wireless device 130, e.g., including control information or reference signals.

Example 13. The method according to any of examples 1-12, further comprising:
initiating (1206) applying the determined configuration.

Example 14. A method performed by a network node (110), the method being for handling a configuration of thresholds, the network node (110) operating in a wireless communications network (100), the method comprising:
receiving (1304) a third indication from a wireless device (130) operating in the wireless communications network (100), the wireless device (130) having a capability of harvesting energy, the third indication indicating a configuration determined by the wireless device (130), the configuration being of one or more thresholds, the one or more thresholds being based at least on a level of energy stored at the wireless device (130), the configuration having been determined by the wireless device (130) based on one or more conditions of the harvesting of the energy at the wireless device (130).

Example 15. The method according to example 14, further comprising:
determining/updating (1305) the configuration of the one or more thresholds used by the wireless device (130), based on received third configuration.

Example 16. The method according to example 15, further comprising:
initiating (1306) applying the determined/updated configuration.

Example 17. The method according to any of examples 14-16, wherein the one or more conditions comprise:
a value of another of the one or more thresholds.

Example 18. The method according to any of examples 14-17, further comprising:
determining (1301) at least one of: a) one or more first indications and b) one or more second parameters for energy harvesting of the wireless device (130), the one or more first indications indicating a function to derive one or more third parameters.

Example 19. The method according to example 18, at least one of the second parameters and the one or more third parameters comprise at least one of:
a rate of harvesting of the energy or harvesting rate, e.g., rₕₐᵣᵥₑₛₜ,
harvesting source type,
energy storage capacity, and
remaining energy.

Example 20. The method according to any of examples 14-19, wherein the one or more conditions comprise a relationship between a current energy level parameter of the wireless device 130, a time parameter, e.g., an offset, and a harvesting rate parameter of the wireless device 130, with respect to a power parameter; for example, the one or more conditions may comprise:

$${p}_{current} + {t}_{offset} \times {r}_{harvest} \leq {p}_{1} ; or$$

$${p}_{current} + {t}_{offset} \times {r}_{harvest} \geq {p}_{2} ;$$

wherein p_{current} is a current energy level parameter of the wireless device (130), t_{offset} is a time parameter, rₕₐᵣᵥₑₛₜ is a harvesting rate parameter of the wireless device (130), and each of p₁ and p₂ is a power parameter.

Example 21. The method according to example 20 and any of examples 18-19, wherein at least one of the power parameters, e.g., p₁ and p₂, is determined based on at least one of:
one of the other parameters, such as the harvesting rate parameter, the harvesting source type, the harvesting source type and the time parameter;

$$e . g . , {p}_{1} = {f}_{1} ( {r}_{harvest} , {h}_{type} , {E}_{cap} , {t}_{offset} ... ) , \\ {p}_{2} = {f}_{2} ( {r}_{harvest} , {h}_{type} , {E}_{cap} , {t}_{offset} ... ) ,$$

and
each other, e.g., p₂=f₃(p₁), p₂=p₁+K, where K is the offset between tp₁ and p₂.

Example 22. The method according to any of examples 18-19 or 21, further comprising:
sending (1302), to the wireless device (130), at least one of: the one or more first indications and the one or more second parameters.

Example 23. The method according to any of examples 18-19 or 21-22, further comprising:
receiving (1303) a second indication from the wireless device (130), the second indication indicating a determined profile of parameters for energy harvesting, and wherein the one or more conditions are based on the determined profile.

Example 24. The method according to any of examples 14-23, wherein a first condition of the one or more conditions is a time window having expired, e.g., g(t:t+a)≤p₁, g(t:t+b)≥p₂, wherein g(t)=[p_{current}+t_{offset}×rₕₐᵣᵥₑₛₜ], and a and b are the time windows within which the level of energy remains above and/or below the respective power parameter.

Example 25. The method according to any of examples 14-24, wherein the one or more thresholds comprise at least one of:
an enabling threshold of at least one of: a Quality of Service, QoS-Flow, a Data Radio Bearer, DRB, a service, and a QoS service,
a disabling threshold of at least one of: the QoS-Flow, the DRB, the service, and the QoS service,
an enter enabling threshold of at least one of: the QoS-Flow, the DRB, the service, and the QoS service,
an enter disabling threshold of at least one of: the QoS-Flow, the DRB, the service, and the QoS service,
a transmission enabling threshold, e.g., of at least one of: the QoS-Flow, the DRB, the service, and the QoS service,
a transmission enabling enter threshold, e.g., of at least one of: the QoS-Flow, the DRB, the service, and the QoS service,
a transmission enabling leave threshold, e.g., of at least one of: the QoS-Flow, the DRB, the service, and the QoS service,
a transmission disabling threshold, e.g., of at least one of: the QoS-Flow, the DRB, the service, and the QoS service,
a transmission disabling enter threshold, e.g., of at least one of: the QoS-Flow, the DRB, the service, and the QoS service,
a transmission disabling leave threshold, e.g., of at least one of: the QoS-Flow, the DRB, the service, and the QoS service,
an energy warning enter threshold, e.g., of at least one of: the QoS-Flow, the DRB, the service, and the QoS service, and
an energy warning leave threshold, e.g., of at least one of: the QoS-Flow, the DRB, the service, and the QoS service.

Example 26. The method according to example 25, wherein the at least one of the one or more thresholds is for one of: a) data transmission, e.g., specifically data transmission, between the wireless communications network 100, e.g., the network node 110 and the wireless device 130, and b) wireless communication between the wireless communications network 100, e.g., the network node 110 and the wireless device 130, e.g., including control information or reference signals.

### Further Extensions and Variations

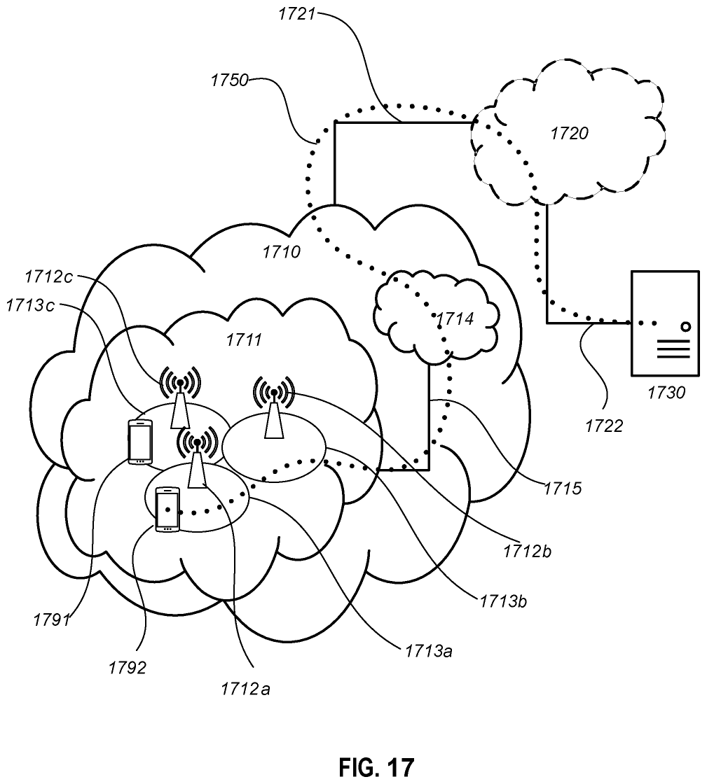

FIG. 17: Telecommunication Network Connected Via an Intermediate Network to a Host Computer in Accordance with Some Embodiments

With reference to FIG. 17, in accordance with an embodiment, a communication system includes telecommunication network 1710 such as the wireless communications network 100, for example, a 3GPP-type cellular network, which comprises access network 1711, such as a radio access network, and core network 1714. Access network 1711 comprises a plurality of network nodes such as the network node 110, and/or the radio network node 111. For example, base stations 1712a, 1712b, 1712c, such as NBs, eNBs, gNBs or other types of wireless access points, each defining a corresponding coverage area 1713a, 1713b, 1713c. Each base station 1712a, 1712b, 1712c is connectable to core network 1714 over a wired or wireless connection 1715. A plurality of wireless devices, such as the wireless device 130, are comprised in the wireless communications network 100. In FIG. 17, a first UE 1791 located in coverage area 1713c is configured to wirelessly connect to, or be paged by, the corresponding base station 1712c. A second UE 1792 in coverage area 1713a is wirelessly connectable to the corresponding base station 1712a. While a plurality of UEs 1791, 1792 are illustrated in this example, the disclosed embodiments are equally applicable to a situation where a sole UE is in the coverage area or where a sole UE is connecting to the corresponding base station 1712. Any of the UEs 1791, 1792 are examples of the wireless device 130.

Telecommunication network 1710 is itself connected to host computer 1730, which may be embodied in the hardware and/or software of a standalone server, a cloud-implemented server, a distributed server or as processing resources in a server farm. Host computer 1730 may be under the ownership or control of a service provider, or may be operated by the service provider or on behalf of the service provider. Connections 1721 and 1722 between telecommunication network 1710 and host computer 1730 may extend directly from core network 1714 to host computer 1730 or may go via an optional intermediate network 1720. Intermediate network 1720 may be one of, or a combination of more than one of, a public, private or hosted network; intermediate network 1720, if any, may be a backbone network or the Internet; in particular, intermediate network 1720 may comprise two or more sub-networks (not shown).

The communication system of FIG. 17 as a whole enables connectivity between the connected UEs 1791, 1792 and host computer 1730. The connectivity may be described as an over-the-top (OTT) connection 1750. Host computer 1730 and the connected UEs 1791, 1792 are configured to communicate data and/or signaling via OTT connection 1750, using access network 1711, core network 1714, any intermediate network 1720 and possible further infrastructure (not shown) as intermediaries. OTT connection 1750 may be transparent in the sense that the participating communication devices through which OTT connection 1750 passes are unaware of routing of uplink and downlink communications. For example, base station 1712 may not or need not be informed about the past routing of an incoming downlink communication with data originating from host computer 1730 to be forwarded (e.g., handed over) to a connected UE 1791. Similarly, base station 1712 need not be aware of the future routing of an outgoing uplink communication originating from the UE 1791 towards the host computer 1730.

In relation to FIGS. 18, 19, 20, 21, and 22, which are described next, it may be understood that a UE is an example of the wireless device 130, and that any description provided for the UE equally applies to the wireless device 130. It may be also understood that the base station is an example of the network node 110, and/or the radio network node 111, and that any description provided for the base station equally applies to the network node 110, and/or the radio network node 111.

FIG. 18: Host Computer Communicating Via a Base Station with a User Equipment Over a Partially Wireless Connection in Accordance with Some Embodiments

Example implementations, in accordance with an embodiment, of the wireless device 130, e.g., a UE, the network node 110, e.g., a base station and host computer discussed in the preceding paragraphs will now be described with reference to FIG. 18. In communication system 1800, such as the wireless communications network 100, host computer 1810 comprises hardware 1815 including communication interface 1816 configured to set up and maintain a wired or wireless connection with an interface of a different communication device of communication system 1800. Host computer 1810 further comprises processing circuitry 1818, which may have storage and/or processing capabilities. In particular, processing circuitry 1818 may comprise one or more programmable processors, application-specific integrated circuits, field programmable gate arrays or combinations of these (not shown) adapted to execute instructions. Host computer 1810 further comprises software 1811, which is stored in or accessible by host computer 1810 and executable by processing circuitry 1818. Software 1811 includes host application 1812. Host application 1812 may be operable to provide a service to a remote user, such as UE 1830 connecting via OTT connection 1850 terminating at UE 1830 and host computer 1810. In providing the service to the remote user, host application 1812 may provide user data which is transmitted using OTT connection 1850.

Communication system 1800 further includes the network node 110, exemplified in FIG. 18 as a base station 1820 provided in a telecommunication system and comprising hardware 1825 enabling it to communicate with host computer 1810 and with UE 1830. Hardware 1825 may include communication interface 1826 for setting up and maintaining a wired or wireless connection with an interface of a different communication device of communication system 1800, as well as radio interface 1827 for setting up and maintaining at least wireless connection 1870 with the wireless device 130, exemplified in FIG. 18 as a UE 1830 located in a coverage area (not shown in FIG. 18) served by base station 1820. Communication interface 1826 may be configured to facilitate connection 1860 to host computer 1810. Connection 1860 may be direct, or it may pass through a core network (not shown in FIG. 18) of the telecommunication system and/or through one or more intermediate networks outside the telecommunication system. In the embodiment shown, hardware 1825 of base station 1820 further includes processing circuitry 1828, which may comprise one or more programmable processors, application-specific integrated circuits, field programmable gate arrays or combinations of these (not shown) adapted to execute instructions. Base station 1820 further has software 1821 stored internally or accessible via an external connection.

Communication system 1800 further includes UE 1830 already referred to. Its hardware 1835 may include radio interface 1837 configured to set up and maintain wireless connection 1870 with a base station serving a coverage area in which UE 1830 is currently located. Hardware 1835 of UE 1830 further includes processing circuitry 1838, which may comprise one or more programmable processors, application-specific integrated circuits, field programmable gate arrays or combinations of these (not shown) adapted to execute instructions. UE 1830 further comprises software 1831, which is stored in or accessible by UE 1830 and executable by processing circuitry 1838. Software 1831 includes client application 1832. Client application 1832 may be operable to provide a service to a human or non-human user via UE 1830, with the support of host computer 1810. In host computer 1810, an executing host application 1812 may communicate with the executing client application 1832 via OTT connection 1850 terminating at UE 1830 and host computer 1810. In providing the service to the user, client application 1832 may receive request data from host application 1812 and provide user data in response to the request data. OTT connection 1850 may transfer both the request data and the user data. Client application 1832 may interact with the user to generate the user data that it provides.

It is noted that host computer 1810, base station 1820 and UE 1830 illustrated in FIG. 18 may be similar or identical to host computer 1730, one of base stations 1712a, 1712b, 1712c and one of UEs 1791, 1792 of FIG. 17, respectively. This is to say, the inner workings of these entities may be as shown in FIG. 18 and independently, the surrounding network topology may be that of FIG. 17.

In FIG. 18, OTT connection 1850 has been drawn abstractly to illustrate the communication between host computer 1810 and UE 1830 via base station 1820, without explicit reference to any intermediary devices and the precise routing of messages via these devices. Network infrastructure may determine the routing, which it may be configured to hide from UE 1830 or from the service provider operating host computer 1810, or both. While OTT connection 1850 is active, the network infrastructure may further take decisions by which it dynamically changes the routing (e.g., on the basis of load balancing consideration or reconfiguration of the network).

Wireless connection 1870 between UE 1830 and base station 1820 is in accordance with the teachings of the embodiments described throughout this disclosure. One or more of the various embodiments improve the performance of OTT services provided to UE 1830 using OTT connection 1850, in which wireless connection 1870 forms the last segment. More precisely, the teachings of these embodiments may improve the latency, signalling overhead, and service interruption and thereby provide benefits such as reduced user waiting time, better responsiveness and extended battery lifetime.

A measurement procedure may be provided for the purpose of monitoring data rate, latency and other factors on which the one or more embodiments improve. There may further be an optional network functionality for reconfiguring OTT connection 1850 between host computer 1810 and UE 1830, in response to variations in the measurement results. The measurement procedure and/or the network functionality for reconfiguring OTT connection 1850 may be implemented in software 1811 and hardware 1815 of host computer 1810 or in software 1831 and hardware 1835 of UE 1830, or both. In embodiments, sensors (not shown) may be deployed in or in association with communication devices through which OTT connection 1850 passes; the sensors may participate in the measurement procedure by supplying values of the monitored quantities exemplified above, or supplying values of other physical quantities from which software 1811, 1831 may compute or estimate the monitored quantities. The reconfiguring of OTT connection 1850 may include message format, retransmission settings, preferred routing etc.; the reconfiguring need not affect base station 1820, and it may be unknown or imperceptible to base station 1820. Such procedures and functionalities may be known and practiced in the art. In certain embodiments, measurements may involve proprietary UE signaling facilitating host computer 1810's measurements of throughput, propagation times, latency and the like. The measurements may be implemented in that software 1811 and 1831 causes messages to be transmitted, in particular empty or ‘dummy’ messages, using OTT connection 1850 while it monitors propagation times, errors etc.

The wireless device embodiments relate to FIG. 12, FIG. 14, FIG. 15 and FIGS. 18-22.

The wireless device 130 may also be configured to communicate user data with a host application unit in a host computer 1810, e.g., via another link such as 1850.

The wireless device 130 may comprise an arrangement as shown in FIG. 15 or in FIG. 18.

The network node embodiments relate to FIG. 13, FIG. 14, FIG. 16 and FIGS. 18-22.

The network node 110 may also be configured to communicate user data with a host application unit in a host computer 1810, e.g., via another link such as 1850.

The network node 110 may comprise an arrangement as shown in FIG. 16 or in FIG. 18.

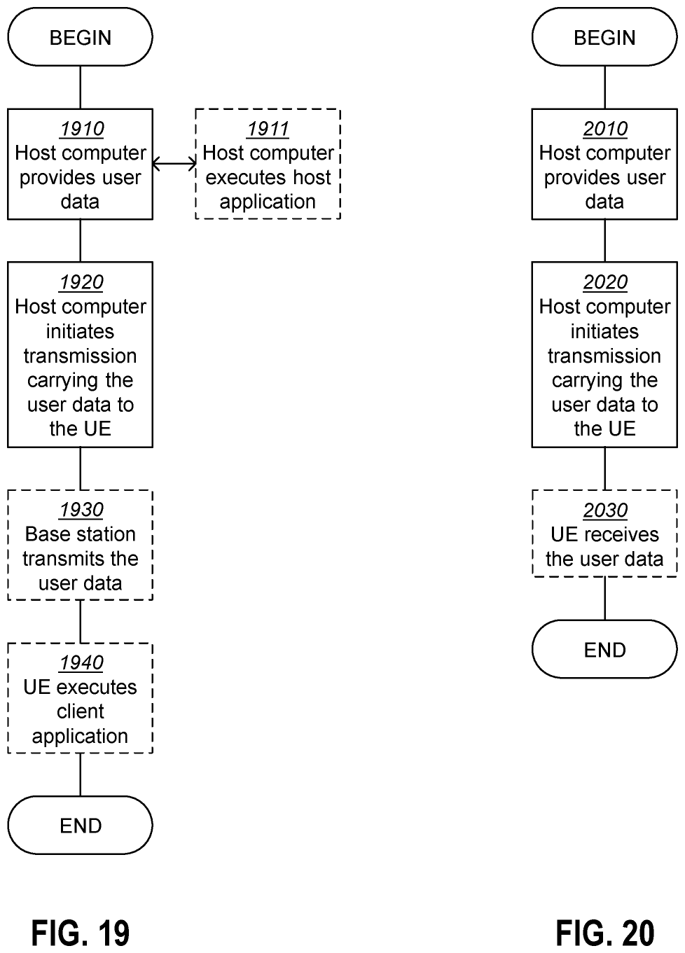

FIG. 19: Methods Implemented in a Communication System Including a Host Computer, a Base Station and a User Equipment in Accordance with Some Embodiments

FIG. 19 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 19 will be included in this section. In step 1910, the host computer provides user data. In substep 1911 (which may be optional) of step 1910, the host computer provides the user data by executing a host application. In step 1920, the host computer initiates a transmission carrying the user data to the UE. In step 1930 (which may be optional), the base station transmits to the UE the user data which was carried in the transmission that the host computer initiated, in accordance with the teachings of the embodiments described throughout this disclosure. In step 1940 (which may also be optional), the UE executes a client application associated with the host application executed by the host computer.

FIG. 20: Methods Implemented in a Communication System Including a Host Computer, a Base Station and a User Equipment in Accordance with Some Embodiments

FIG. 20 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 20 will be included in this section. In step 2010 of the method, the host computer provides user data. In an optional substep (not shown) the host computer provides the user data by executing a host application. In step 2020, the host computer initiates a transmission carrying the user data to the UE. The transmission may pass via the base station, in accordance with the teachings of the embodiments described throughout this disclosure. In step 2030 (which may be optional), the UE receives the user data carried in the transmission.

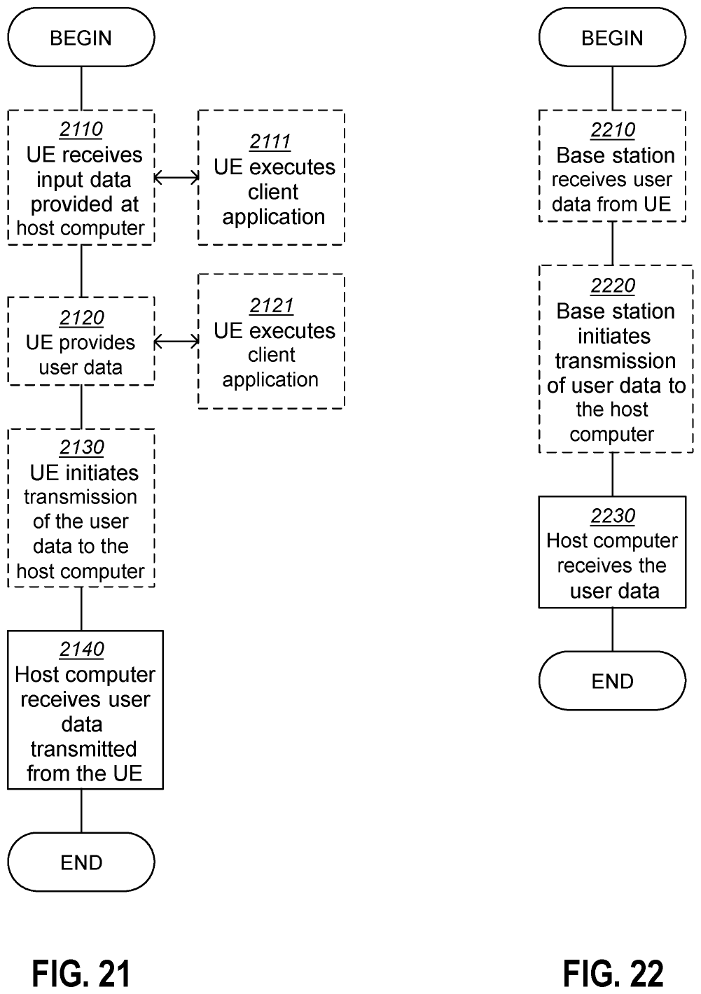

FIG. 21: Methods Implemented in a Communication System Including a Host Computer, a Base Station and a User Equipment in Accordance with Some Embodiments

FIG. 21 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 21 will be included in this section. In step 2110 (which may be optional), the UE receives input data provided by the host computer. Additionally or alternatively, in step 2120, the UE provides user data. In substep 2121 (which may be optional) of step 2120, the UE provides the user data by executing a client application. In substep 2111 (which may be optional) of step 2110, the UE executes a client application which provides the user data in reaction to the received input data provided by the host computer. In providing the user data, the executed client application may further consider user input received from the user. Regardless of the specific manner in which the user data was provided, the UE initiates, in substep 2130 (which may be optional), transmission of the user data to the host computer. In step 2140 of the method, the host computer receives the user data transmitted from the UE, in accordance with the teachings of the embodiments described throughout this disclosure.

FIG. 22: Methods Implemented in a Communication System Including a Host Computer, a Base Station and a User Equipment in Accordance with Some Embodiments

FIG. 22 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 22 will be included in this section. In step 2210 (which may be optional), in accordance with the teachings of the embodiments described throughout this disclosure, the base station receives user data from the UE. In step 2220 (which may be optional), the base station initiates transmission of the received user data to the host computer. In step 2230 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### Further Numbered Embodiments

1. A base station configured to communicate with a user equipment (UE), the base station comprising a radio interface and processing circuitry configured to perform one or more of the actions described herein as performed by the network node 110.

5. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform one or more of the actions described herein as performed by the network node 110.

6. The communication system of embodiment 5, further including the base station.

7. The communication system of embodiment 6, further including the UE, wherein the UE is configured to communicate with the base station.

8. The communication system of embodiment 7, wherein:
the processing circuitry of the host computer is configured to execute a host application, thereby providing the user data; and
the UE comprises processing circuitry configured to execute a client application associated with the host application.

11. A method implemented in a base station, comprising one or more of the actions described herein as performed by the network node 110.

15. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs one or more of the actions described herein as performed by the network node 110.

16. The method of embodiment 15, further comprising:
at the base station, transmitting the user data.

17. The method of embodiment 16, wherein the user data is provided at the host computer by executing a host application, the method further comprising:
at the UE, executing a client application associated with the host application.

21. A user equipment (UE) configured to communicate with a base station, the UE comprising a radio interface and processing circuitry configured to perform one or more of the actions described herein as performed by the wireless device 130.

25. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's processing circuitry configured to perform one or more of the actions described herein as performed by the wireless device 130.

26. The communication system of embodiment 25, further including the UE.

27. The communication system of embodiment 26, wherein the cellular network further includes a base station configured to communicate with the UE.

28. The communication system of embodiment 26 or 27, wherein:
the processing circuitry of the host computer is configured to execute a host application, thereby providing the user data; and
the UE's processing circuitry is configured to execute a client application associated with the host application.

31. A method implemented in a user equipment (UE), comprising one or more of the actions described herein as performed by the wireless device 130.

35. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs one or more of the actions described herein as performed by the wireless device 130.

36. The method of embodiment 35, further comprising:
at the UE, receiving the user data from the base station.

41. A user equipment (UE) configured to communicate with a base station, the UE comprising a radio interface and processing circuitry configured to perform one or more of the actions described herein as performed by the wireless device 130.

45. A communication system including a host computer comprising:
a communication interface configured to receive user data originating from a transmission from a user equipment (UE) to a base station,
wherein the UE comprises a radio interface and processing circuitry, the UE's processing circuitry configured to: perform one or more of the actions described herein as performed by the wireless device 130.

46. The communication system of embodiment 45, further including the UE.

47. The communication system of embodiment 46, further including the base station, wherein the base station comprises a radio interface configured to communicate with the UE and a communication interface configured to forward to the host computer the user data carried by a transmission from the UE to the base station.

48. The communication system of embodiment 46 or 47, wherein:
the processing circuitry of the host computer is configured to execute a host application; and
the UE's processing circuitry is configured to execute a client application associated with the host application, thereby providing the user data.

49. The communication system of embodiment 46 or 47, wherein:
the processing circuitry of the host computer is configured to execute a host application, thereby providing request data; and
the UE's processing circuitry is configured to execute a client application associated with the host application, thereby providing the user data in response to the request data.

51. A method implemented in a user equipment (UE), comprising one or more of the actions described herein as performed by the wireless device 130.

52. The method of embodiment 51, further comprising:
providing user data; and
forwarding the user data to a host computer via the transmission to the base station.

55. A method implemented in a communication system including a host computer, a base station and a user equipment (UE), the method comprising:
at the host computer, receiving user data transmitted to the base station from the UE, wherein the UE performs one or more of the actions described herein as performed by the wireless device 130.

56. The method of embodiment 55, further comprising:
at the UE, providing the user data to the base station.

57. The method of embodiment 56, further comprising:
at the UE, executing a client application, thereby providing the user data to be transmitted; and
at the host computer, executing a host application associated with the client application.

58. The method of embodiment 56, further comprising:
at the UE, executing a client application; and
at the UE, receiving input data to the client application, the input data being provided at the host computer by executing a host application associated with the client application,
wherein the user data to be transmitted is provided by the client application in response to the input data.

61. A base station configured to communicate with a user equipment (UE), the base station comprising a radio interface and processing circuitry configured to perform one or more of the actions described herein as performed by the network node 110.

65. A communication system including a host computer comprising a communication interface configured to receive user data originating from a transmission from a user equipment (UE) to a base station, wherein the base station comprises a radio interface and processing circuitry, the base station's processing circuitry configured to perform one or more of the actions described herein as performed by the network node 110.

66. The communication system of embodiment 65, further including the base station.

67. The communication system of embodiment 66, further including the UE, wherein the UE is configured to communicate with the base station.

68. The communication system of embodiment 67, wherein:
the processing circuitry of the host computer is configured to execute a host application;
the UE is configured to execute a client application associated with the host application, thereby providing the user data to be received by the host computer.

71. A method implemented in a base station, comprising one or more of the actions described herein as performed by the network node 110.

75. A method implemented in a communication system including a host computer, a base station and a user equipment (UE), the method comprising:
at the host computer, receiving, from the base station, user data originating from a transmission which the base station has received from the UE, wherein the UE performs one or more of the actions described herein as performed by the wireless device 130.

76. The method of embodiment 75, further comprising:
at the base station, receiving the user data from the UE.

77. The method of embodiment 76, further comprising:
at the base station, initiating a transmission of the received user data to the host computer.

### REFERENCES

1. RP-210918, “Revised WID on support of reduced capability NR devices”, Nokia and Ericsson, 3GPP TSG RAN #91e, March 2021.
2. TR 38.875 V17.0.0, “Study on support of reduced capability NR devices (Release 17)”, March 2021.
3. TS 36.331, V16.4.1, “NR; Radio Resource Control (RRC) protocol specification”, March 2021.
4. TS 36.306, V16.4.0, “NR; User Equipment (UE) radio access capabilities”, March 2021.
5. TS 38.300, V16.5.0, “NR; NR and NG-RAN Overall Description”, March 2021.

1. A method performed by a wireless device, the method being for handling a configuration of thresholds, the wireless device having a capability of harvesting energy, the wireless device operating in a wireless communications network, the method comprising:
determining a configuration of one or more thresholds, the one or more thresholds being based at least on a level of energy stored at the wireless device, the determining of the configuration being based on one or more conditions of the harvesting of the energy at the wireless device.

2. The method according to claim 1, wherein the one or more conditions comprise:
a value of another of the one or more thresholds.

3. The method according to claim 1, further comprising:
determining a profile of parameters for energy harvesting, and wherein the one or more conditions are based on the determined profile, wherein the parameters are based on at least one of:
i. one or more first parameters determined autonomously by the wireless device,
ii. one or more second parameters received from a network node operating in the wireless communications network, and
iii. one or more first indications received from the network node, the one or more first indications indicating a function to derive one or more third parameters.

4. The method according to claim 3, wherein the parameters in the profile comprise at least one of:
a rate of harvesting of the energy or harvesting rate,
harvesting source type,
energy storage capacity, and
remaining energy.

5. The method according to claim 1, wherein the one or more conditions comprise a relationship between a current energy level parameter of the wireless device, a time parameter, and a harvesting rate parameter of the wireless device, with respect to a power parameter.

6. The method according to claim 5, wherein at least one power parameter is determined based on at least one of:
one of the other parameters and
each other.

7. The method according to claim 3, further comprising:
receiving, from the network node, at least one of: the one or more first indications and the one or more second parameters.

8. The method according to claim 3, further comprising:
sending a second indication to the network node, the second indication indicating the determined profile.

9. The method according to claim 1, wherein a first condition of the one or more conditions is a time window having expired.

10. The method according to claim 1, further comprising:
sending a third indication to a network node operating in the wireless communications network, the third indication indicating the determined configuration.

11. The method according to claim 1, wherein the one or more thresholds comprise at least one of:
an enabling threshold of at least one of: a Quality of Service, QoS-Flow, a Data Radio Bearer, DRB, a service, and a QoS service,
a disabling threshold of at least one of: the QoS-Flow, the DRB, the service, and the QoS service,
an enter enabling threshold of at least one of: the QoS-Flow, the DRB, the service, and the QoS service,
an enter disabling threshold of at least one of: the QoS-Flow, the DRB, the service, and the QoS service,
a transmission enabling threshold,
a transmission enabling enter threshold,
a transmission enabling leave threshold,
a transmission disabling threshold,
a transmission disabling enter threshold,
a transmission disabling leave threshold,
an energy warning enter threshold, and
an energy warning leave threshold.

12. The method according to claim 11, wherein the at least one of the one or more thresholds is for one of: a) data transmission between the wireless communications network and the wireless device, and b) wireless communication between the wireless communications network and the wireless device.

13. The method according to claim 1, further comprising:
initiating applying the determined configuration.

14. The method according to claim 8, wherein the wireless device is configured by the network node with at least one of: periodic, semi-static or aperiodic reporting, and wherein the sending of at least one of the second indication and the third indication is performed based on the configured reporting.

15. A method performed by a network node, the method being for handling a configuration of thresholds, the network node operating in a wireless communications network, the method comprising:
receiving a third indication from a wireless device operating in the wireless communications network, the wireless device having a capability of harvesting energy, the third indication indicating a configuration determined by the wireless device, the configuration being of one or more thresholds, the one or more thresholds being based at least on a level of energy stored at the wireless device, the configuration having been determined by the wireless device based on one or more conditions of the harvesting of the energy at the wireless device.

16. The method according to claim 15, further comprising:
determining the configuration of the one or more thresholds used by the wireless device, based on received third configuration.

17. The method according to claim 16, further comprising:
initiating applying the determined configuration.

18. The method according to claim 15, wherein the one or more conditions comprise:
a value of another of the one or more thresholds.

19. The method according to claim 15, further comprising:
determining at least one of: a) one or more first indications and b) one or more second parameters for energy harvesting of the wireless device, the one or more first indications indicating a function to derive one or more third parameters.

20. The method according to claim 19, at least one of the second parameters and the one or more third parameters comprise at least one of:
a rate of harvesting of the energy or harvesting rate,
harvesting source type,
energy storage capacity, and
remaining energy.

21-56. (canceled)
